(19) United States
(12) Patent Application Publication
(10) Pub. No.: US 2015/0112880 A1
(43) Pub. Date: Apr. 23, 2015

(54) Systems and Methods for Facilitating User Interactions

(71) Applicant: WHOAT, LLC, Menlo Park, CA (US)

(72) Inventors: L. Leonard Blaylock, IV, Menlo Park, CA (US); William C. Kennedy, III, Dallas, TX (US); Ron Rodenberg, Dallas, TX (US)

(21) Appl. No.: 14/523,826

(22) Filed: Oct. 24, 2014

Related U.S. Application Data
(63) Continuation of application No. PCT/US2013/038522, filed on Apr. 26, 2013.
(60) Provisional application No. 61/639,033, filed on Apr. 26, 2012.
(60) Provisional application No. 61/798,075, filed on Mar. 15, 2013.

(51) Int. Cl. G06Q 50/00; H04L 29/06; G06F 17/30; H04L 29/08

(52) U.S. Cl. CPC G06Q 50/01; H04L 67/10; H04L 63/102; G06F 17/30867
USPC 705/319; 726/4; 707/736; 707/770

(57) ABSTRACT

A computer-implemented method for facilitating user interactions comprises receiving, with the aid of a system having a computer processor, a request from a requester for making an introduction to a target. The target is directly linked to a facilitator, which can be a user in the requester's company or user group. The system requests authorization from the facilitator to introduce the requester to the target. Upon receiving authorization from the facilitator, the system introduces the requester to the target. In some cases, the system does not reveal the identity of the facilitator to the requester.

### CROSS-REFERENCE

This application is a continuation of PCT Application No. PCT/US2013/038522, filed Apr. 26, 2013, which claims priority to U.S. Provisional Patent Application No. 61/639,033, filed Apr. 26, 2012, and U.S. Provisional Patent Application No. 61/798,075, filed Mar. 15, 2013, each of which is entirely incorporated herein by reference.

### BACKGROUND

Social networking web sites, such as Linkedln®, enable users to search for and find other users. In some cases, users are searched for and matched on the basis of the degree of separation from one user to another, such as once removed or twice removed. Such systems, however, do not enable users to refer one another in a manner that provides a certain level of trust.

Linkedln, for instance, allows registered users to maintain a list of contact details of people with whom they are linked to, called “connections”, but may not have any real relationship with. Users can invite anyone (whether a site user or not) to become a connection. The invitee can accept the invitation, or select “I don't know” or “Spam.”The list of connections can be used in a number of ways. A contact network may be built up consisting of direct connections, the connections of each of their connections (termed second-degree connections), and also the connections of second-degree connections (termed third-degree connections). This can be used to gain an introduction to someone a person wishes to know.

### SUMMARY

Although social networking services such as Linkedln enable a user to gain an introduction to other users, such services do not provide a level of trust with such introductions. In addition, a user receiving a request may be compelled to make an introduction even if the user does not wish to make the introduction. This generates considerable pressure for the user—the user must make the introduction, or otherwise risk adversely impacting the user's relationship with the requester.

The disclosure provides systems and methods for enabling users to facilitate introductions in a manner that does not require that they make such introductions. Systems provided herein, by leveraging pre-existing relationships among contacts, provide a level of trust accompanying such introductions.

Systems provided herein enable the formation of relationships (e.g., business relationships, social relationships) based on existing relationships among uses, as may be at least partially defined by contact information stored on electronic devices of users, such as, for example, a contacts address book stored on a Smart phone or portable computer of a user.

Provided herein are systems and methods that enable a first user (“requester”) to find a second user (“target”) through one or more contacts or connections of a third user (“facilitator”). The requester can subsequently request an introduction to the target through the facilitator. The facilitator can permit or deny the request for the introduction without having the facilitator's identity revealed to the requester. In some situations, absent authorization from the facilitator, the contact information of the target is not revealed to the requester.

Some embodiments provide systems to enable a user to leverage the user's contacts, such as contacts stored in a contacts database on an electronic device of the user or a network location (e.g., email account, social network), to find other users, or bring other users in contact with one another. Systems provided here can enable the user to leverage other users in the user's contacts to find other users, such as by way of introduction. The introduction can be to another user that is of business or social interest to the user, such as a potential business partner or friend. In some cases, a user can leverage other users among the user's contacts, at least some of which the user may trust, to make improved life decisions, such as work decisions, purchasing decisions, travel decisions. Such decisions can be based on recommendations or comments provided by the user's contacts.

Some embodiments provide systems and methods for updating a user's contacts, which may include other users. In some cases the contacts are updated on the basis of the level of information the user has on another user among the user's contacts. The user's contacts can be updated to include current contact information of another user.

Some embodiments provide systems that allow the Requestor and/or the facilitator to add certain filters to restrict whom they want to network with. The user can enable a setting to say, for example, that they only want to play the WishList with people who are already in each respective phone, and/or in their company, and/or a common group both members have opted into and/or use location awareness to only want to play the WishList with people in close proximity if being used on their phone as a trade show or other meet up. Systems and methods provided herein can be implemented on various platforms, such as electronics devices (e.g., portable electronic devices), personal computers, mainframes, or servers. Systems and methods provided herein can enable a user to manage the user's contacts with the aid of a user interface, such as a graphical user interface (GUI).

Some embodiments provide systems and methods for making user referrals. In some cases, the system enables a user to refer products or services to other users that are in the user's list of contacts. The system can enable the user to refer products or services to the other users, which can include users that are within one degree of separation from the user. The referral can be by way of a rating system. The user can refer products or services to other users the user is connected to, such as on a social networking service (e.g., Facebook®) or a list of contacts.

The present disclosure provides systems that can determine common contacts based on one or more common identifying information for a particular user in a contacts database (or list) of two or more users. In some cases, a system can assign a degree of commonality to common contacts based on the degree of identifying information in common. For instance, User A and User B have a phone number and email address of User C in common, while User A and User B have only an email address of User D in Common. In such a case, the system can rank User C higher in a list of common contacts of User A and User B than User D. In some cases, the number of common contacts between two users can be used to rank the potential synergy between the two users. In some embodiments, the more common contacts there are between two users, the more likely it will be that they can help each other and be of interest to each other.

An aspect of the present disclosure provides a computer-implemented method for facilitating user introductions, comprising (a) receiving a request from a requester for an introduction to a target; (b) conducting, with the aid of a computer processor, a search for one or more facilitators that are directly linked to the target; (c) requesting authorization from a given facilitator among the one or more facilitators to introduce the requester to the target, wherein the authorization is requested with the aid of an electronic notification on a user interface of an electronic display of the given facilitator; and (d) upon receiving authorization from the given facilitator, revealing the identity of the given facilitator to the requester, wherein the requester is subsequently introduced to the target. In an embodiment, in (c), the given facilitator is anonymous to the requester. In another embodiment, the requester and the one or more facilitators belong to an affiliate network. In another embodiment, the target is not part of the affiliate network. In another embodiment, the given facilitator is among a plurality of facilitators in the search of (b). In another embodiment, the method further comprises authenticating the requester upon receiving the request in (a). In another embodiment, the electronic notification is an electronic mail, push notification, instant message or a text message. In another embodiment, the requester is introduced to the target with the aid of the given facilitator. In another embodiment, the method further comprises, subsequent to (d), directing an electronic communication to the requester with identifying information of the given facilitator. In another embodiment, the method further comprises directing an electronic notification to the requester that authorization from the given facilitator has been received.

Another aspect of the present disclosure provides a computer-implemented method for facilitating user introductions, comprising (a) receiving a request from a requester for an introduction to a target, wherein the target is directly linked to a facilitator, and wherein the requester and facilitator belong to an affiliate entity; (b) requesting, with the aid of a computer processor, authorization from the facilitator to introduce the requester to the target, wherein the authorization is requested with the aid of an electronic notification on a user interface of an electronic display of the facilitator, wherein the identity of the facilitator is not identified to the requester; and (c) upon receiving authorization from the facilitator, introducing the requester to the target. In an embodiment, the target is not in the affiliate entity. In another embodiment, the user interface is a graphical user interface. In another embodiment, the method further comprises authenticating the requester upon receiving the request in (a). In another embodiment, the electronic notification is an electronic mail push notification, instant message or a text message. In another embodiment, the method further comprises, in (c), directing an electronic communication to the target with identifying information of the requester.

Another aspect of the present disclosure provides a computer-implemented method for facilitating user introductions, comprising (a) reviewing, with the aid of a computer processor, graphical and/or textual content on a web site; (b) determining, with the aid of a computer processor, one or more targets from the content for introduction to a requester; (c) displaying, on a user interface of the requester, a list having the one or more targets, wherein the list is generated upon reviewing the graphical and/or textual content on the web site; (d) receiving a request from the requester for an introduction to a given target among the one or more targets, wherein the given target is directly linked to a facilitator, and wherein the requester and facilitator belong to an affiliate entity; (e) requesting, with the aid of a computer processor, authorization from the facilitator to introduce the requester to the given target; and (f) upon receiving authorization from the facilitator, facilitating the introduction between the requester and the given target. In an embodiment, in (d), the facilitator is anonymous to the requester. In another embodiment, in (e), the introduction is facilitated by revealing the identity of the facilitator to the requester. In another embodiment, the authorization is requested with the aid of an electronic notification on a user interface of an electronic display of the facilitator. In another embodiment, the electronic notification is an electronic mail, push notification, instant message or a text message. In another embodiment, the given target is not in the affiliate entity. In another embodiment, the user interface is a graphical user interface. In another embodiment, the method further comprises authenticating the requester upon receiving the request in (c). In another embodiment, the method further comprises, in (e), directing an electronic communication to the target with identifying information of the requester.

Another aspect of the present disclosure provides a computer-implemented method for facilitating user introductions, comprising (a) receiving a request from a requester for an introduction to a target, wherein the target is directly linked to a facilitator; (b) requesting, with the aid of a computer processor, authorization from the facilitator for making the introduction; (c) upon receiving authorization from the facilitator, (i) introducing the requester to the target and/or (ii) revealing the identity of the facilitator to the requester; and (d) providing, with the aid of a computer processor, the facilitator an introduction credit for use in requesting an introduction from the requester or another user. In an embodiment, the requester and the facilitator belong to an affiliate network. In another embodiment, the target does not belong to the affiliate network. In another embodiment, the identity of the facilitator is not identified to the requester. In another embodiment, the authorization is requested with the aid of an electronic communication directed to the facilitator for display on a user interface of an electronic display of the facilitator. In another embodiment, the electronic communication is an electronic mail or a text message. In another embodiment, the user interface is a graphical user interface. In another embodiment, the method further comprises authenticating the requester upon receiving the request in (a). In another embodiment, the method further comprises storing the introduction credit in a memory location. In another embodiment, in (c), the requester is introduced to the target by directing an electronic communication to the target with identifying information of the requester.

Another aspect of the present disclosure provides a computer-implemented method for updating user contact information, comprising (a) reviewing, with the aid of a computer processor, contact information relating to a first user in a contacts database of a second user; (b) determining, with the aid of a computer processor, if the contact information is outdated; and (c) if the contact information is outdated, requesting authorization from the first user to (i) update the contact information and/or (ii) notify the second user that the contact information is outdated. In an embodiment, the authorization is requested with the aid of an electronic notification on a user interface of an electronic display of the first user. In another embodiment, the electronic notification is an electronic mail, push message, instant message or a text message. In another embodiment, the user interface is a graphical user interface. In another embodiment, the method further comprises notifying second user that the contact information is outdated. In another embodiment, the method further comprises updating the contact information in the contacts database of the second user. In another embodiment, in (c), authorization is requested if the first user has been verified.

Another aspect of the present disclosure provides a computer-implemented method for facilitating user introductions, comprising (a) providing, on a user interface of an electronic device of a requester, one or more targets to the requester; (b) receiving a request from the requester to place a given target among the one or more targets on a wish list of the requester, wherein the wish list is maintained in a memory location; (c) providing the given target in the wish list; and (d) conducting, with the aid of a computer processor in communication with the memory location, a search for one or more facilitators that are directly linked to the target. In an embodiment, a given facilitator among the one or more facilitators has a target included in a wish list of the given facilitator, wherein the target is directly linked to the requester. In another embodiment, the one or more facilitators are in an affiliate network of the requester. In another embodiment, the target is not in the affiliate network. In another embodiment, the method further comprises identifying a facilitator from the one or more facilitators, and facilitating the introduction between the requester and the target with the aid of the facilitator. In another embodiment, the facilitator is anonymous to the requester.

Another aspect of the present disclosure provides a computer-implemented method for providing product and/or service referrals, comprising (a) receiving, from a first user, an indication of a willingness to provide a referral for a product and/or service; (b) receiving a request from a second user for the referral; (c) determining, with the aid of a computer processor, if the second user is in a contacts database of the first user; (d) if the second user is in the contacts database of the first user, requesting the referral from the first user; and (e) providing the referral to the second user. In an embodiment, the contacts database is associated with a social network of the first user. In another embodiment, (c) further comprises determining if the first user is in a contacts database of the second user. In another embodiment, the method further comprises, in (d), requesting the referral from the first user if the first user is in the contacts database of the second user. In another embodiment, the first user and second user are in an affiliate network. In another embodiment, in (e), the referral is provided on a user interface of an electronic device of the second user.

Another aspect of the present disclosure provides a computer-implemented method for providing potential deals, comprising (a) conducting, with the aid of a computer processor, a search of a deals database for potential deals, wherein the search is conducted based on search criteria inputted by a first user; (b) displaying, on an electronic display of an electronic device of the first user, a list of one or more results that meet the search criteria, wherein a given result of the one or more results is associated with a deal that is promoted by a second user; (c) identifying, with the aid of a computer processor, a third user that is a common contact between the first user and the second user; and (d) providing identifying information of the third user on the electronic display. In an embodiment, the one or more results are generated based on a correlation with successful deals. In another embodiment, the first user and third user are in an affiliate network. In another embodiment, the second user is not in the affiliate network. In another embodiment, the second user is anonymous to the first user. In another embodiment, the method further comprises, subsequent to (d), introducing the first user to the second user with the aid of the third user. In another embodiment, the potential deals are real estate deals.

Another aspect of the present disclosure provides a computer-implemented method for facilitating user introductions, comprising (a) conducting, with the aid of a computer processor, a search of a database for one or more targets that match a profile provided by a requester; (b) conducting, with the aid of a computer processor, a search for one or more facilitators that are directly linked to a given target among the one or more targets; and (c) alerting the requester of the presence of a given facilitator among the one or more facilitators that is directly linked to the given target. In an embodiment, in (c), the given facilitator is anonymous with respect to the requester. In another embodiment, the method further comprises generating, with the aid of a computer processor, the profile. In another embodiment, the method further comprises requesting authorization from the given facilitator to introduce the requester to the target, wherein the authorization is requested with the aid of an electronic communication directed to the facilitator for display on a user interface of an electronic display of the given facilitator. In another embodiment, the method further comprises revealing the identity of the given facilitator to the requester upon receiving authorization from the given facilitator, wherein the requester is subsequently introduced to the target. In another embodiment, the given facilitator and requester are in an affiliate network. In another embodiment, the target is not in the affiliate network. In another embodiment, the profile comprises information selected from the group consisting of company size, industry, number of employees, net income %, company real estate and company expenditure. In another embodiment, in (c), an alert is provided on an electronic display of an electronic device of the requester.

Another aspect of the present disclosure provides machine-executable code that, upon execution by one or more computer processors, implements any of the methods above or elsewhere herein.

Another aspect of the present disclosure provides a system comprising a memory location comprising machine-executable code implementing any of the methods above or elsewhere herein, and a computer processor in communication with the memory location. The computer processor can execute the machine executable code to implement any of the methods above or elsewhere herein.

Another aspect of the present disclosure provides a system, comprising (a) one or more computer processors; and (b) a memory location comprising machine-executable code that, upon execution by the one or more computer processors, implements a method, the method comprising: (i) receiving a request from a requester for an introduction to a target; (ii) conducting a search for one or more facilitators that are directly linked to the target; (iii) requesting authorization from a given facilitator among the one or more facilitators to introduce the requester to the target, wherein the authorization is requested with the aid of an electronic notification on a user interface of an electronic display of the given facilitator; and (iv) upon receiving authorization from the given facilitator, revealing the identity of the given facilitator to the requester, wherein the requester is subsequently introduced to the target.

Another aspect of the present disclosure provides system, comprising (a) one or more computer processors; and (b) a memory location comprising machine-executable code that, upon execution by the one or more computer processors, implements a method, the method comprising (i) receiving a request from a requester for an introduction to a target, wherein the target is directly linked to a facilitator, and wherein the requester and facilitator belong to an affiliate entity; (ii) requesting authorization from the facilitator to introduce the requester to the target, wherein the authorization is requested with the aid of an electronic notification on a user interface of an electronic display of the facilitator, wherein the identity of the facilitator is not identified to the requester; and (iii) upon receiving authorization from the facilitator, introducing the requester to the target.

Another aspect of the present disclosure provides a system, comprising (a) one or more computer processors; and (b) a memory location comprising machine-executable code that, upon execution by the one or more computer processors, implements a method, the method comprising: (i) reviewing graphical and/or textual content on a web site; (ii) determining one or more targets from the content for introduction to a requester; (iii) displaying, on a user interface of the requester, a list having the one or more targets, wherein the list is generated upon reviewing the graphical and/or textual content on the web site; (iv) receiving a request from the requester for an introduction to a given target among the one or more targets, wherein the given target is directly linked to a facilitator, and wherein the requester and facilitator belong to an affiliate entity; (v) requesting authorization from the facilitator to introduce the requester to the given target; and (vi) upon receiving authorization from the facilitator, facilitating the introduction between the requester and the given target.

Another aspect of the present disclosure provides a system, comprising (a) one or more computer processors; and (b) a memory location comprising machine-executable code that, upon execution by the one or more computer processors, implements a method, the method comprising (i) receiving a request from a requester for an introduction to a target, wherein the target is directly linked to a facilitator; (ii) requesting authorization from the facilitator for making the introduction; (iii) upon receiving authorization from the facilitator, introducing the requester to the target and/or revealing the identity of the facilitator to the requester; and (iv) providing the facilitator an introduction credit for use in requesting an introduction from the requester or another user.

Another aspect of the present disclosure provides a system, comprising (a) one or more computer processors; and (b) a memory location comprising machine-executable code that, upon execution by the one or more computer processors, implements a method, the method comprising (i) reviewing contact information relating to a first user in a contacts database of a second user; (ii) determining if the contact information is outdated; and (iii) if the contact information is outdated, requesting authorization from the first user to update the contact information and/or notify the second user that the contact information is outdated.

Another aspect of the present disclosure provides a system, comprising (a) one or more computer processors; and (b) a memory location comprising machine-executable code that, upon execution by the one or more computer processors, implements a method, the method comprising (i) providing, on a user interface of an electronic device of a requester, one or more targets to the requester; (ii) receiving a request from the requester to place a given target among the one or more targets on a wish list of the requester, wherein the wish list is maintained in a memory location; (iii) providing the given target in the wish list; and (iv) conducting, with the aid of a computer processor in communication with the memory location, a search for one or more facilitators that are directly linked to the target.

Another aspect of the present disclosure provides a system, comprising (a) one or more computer processors; and (b) a memory location comprising machine-executable code that, upon execution by the one or more computer processors, implements a method, the method comprising (i) receiving, from a first user, an indication of a willingness to provide a referral for a product and/or service; (ii) receiving a request from a second user for the referral; (iii) determining if the second user is in a contacts database of the first user; (iv) if the second user is in the contacts database of the first user, requesting the referral from the first user; and (v) providing the referral to the second user.

Another aspect of the present disclosure provides a system, comprising (a) one or more computer processors; and (b) a memory location comprising machine-executable code that, upon execution by the one or more computer processors, implements a method, the method comprising (i) conducting a search of a deals database for potential deals, wherein the search is conducted based on search criteria inputted by a first user; (ii) displaying, on an electronic display of an electronic device of the first user, a list of one or more results that meet the search criteria, wherein a given result of the one or more results is associated with a deal that is promoted by a second user; (iii) identifying a third user that is a common contact between the first user and the second user; and (iv) providing identifying information of the third user on the electronic display.

Another aspect of the present disclosure provides a system, comprising (a) one or more computer processors; and (b) a memory location comprising machine-executable code that, upon execution by the one or more computer processors, implements a method, the method comprising (i) conducting a search of a database for one or more targets that match a profile provided by a requester; (ii) conducting a search for one or more facilitators that are directly linked to a given target among the one or more targets; and (iii) alerting the requester of the presence of a given facilitator among the one or more facilitators that is directly linked to the given target.

Systems above or elsewhere herein may have features identical to those described in the context of methods above or elsewhere herein. In systems above or elsewhere herein, alone or in combination, the facilitator may be anonymous to the requester. In some cases, the identity of the facilitator can be identified to the requester. The requester and the facilitator may belong to an affiliate network. The target may not be part of the affiliate network.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates a workflow, in accordance with an embodiment of the invention;

FIG. 2 schematically illustrates an electronic communication from the system of FIG. 1, in accordance with an embodiment of the invention;

FIG. 3 schematically illustrates a system for implementing methods provided herein, in accordance with an embodiment of the invention;

FIG. 4 shows a web browser displaying web content and a browser plug-in (arrow 1) for bringing the browser in communication with a system for facilitating user introductions, in accordance with an embodiment of the invention;

FIG. 5 shows a drop-down frame from the plug-in of FIG. 4, in accordance with an embodiment of the invention;

FIG. 6 shows a window for requesting an introduction as implemented with the aid of the plug-in of FIG. 4, in accordance with an embodiment of the invention;

FIG. 7 shows a WishList (also “wish list” herein), in accordance with an embodiment of the invention;

FIG. 8 shows a graphical user interface (GUI) that enables a user to sign up for email alerts and criteria, in accordance with an embodiment of the invention;

FIGS. 9 and 10 show GUI's for providing search criteria to the system, in accordance with an embodiment of the invention;

FIG. 11 shows an example of a method for introducing Fred Smith to Rick Martin through Carmen Jones, in accordance with an embodiment of the invention;

FIGS. 12 and 13 show a browser window having a frame showing the results of a search directed at web content, in accordance with an embodiment of the invention;

FIG. 14 is a workflow showing the formation of contacts list, in accordance with an embodiment of the invention;

FIGS. 15-17 are screenshots of a GUI showing a search directed at potential real estate transactions, in accordance with an embodiment of the invention;

FIG. 18 shows database tables having users of a system configured to facilitate user introductions, in accordance with an embodiment of the invention;

FIG. 19 schematically illustrates a root resolving process;

FIG. 20 shows a workflow for a root resolving process;

FIG. 21 shows a workflow for a merging process;

FIG. 22 shows a workflow for a collapse process;

FIG. 23 shows a workflow for determining common contacts;

FIG. 24 is a screenshot of a GUI; and

FIG. 25 is another screenshot of a GUI.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “user,” as used herein, generally refers to an individual or entity (e.g., company) with access to a system for matching users. A user can be an individual or entity requesting an introduction from another user, such as from a facilitator to a target.

The term “requester,” as used herein, generally refers to a user looking for an introduction or referral to another user or entity.

The term “facilitator,” as used herein, generally refers to a user having a relationship with another person (e.g., target) that may be of value to a requester. A facilitator may bring a requester in contact with a target.

The term “target,” as used herein, generally refers to a user or entity (e.g., group, organization, company) to which a requester desires to have an introduction or referral. A requester may wish to be referred or introduced to the target through a facilitator.

The term “wish list,” as used herein, generally refers to a list of one or more targets for potential future introduction to a requester. A requester may wish to be introduced to a target on the wish list. The introduction may or may not occur based on the occurrence of a future condition, such as the identification of a facilitator that may aid in facilitating the introduction.

The term “contact information,” as used herein, generally refers to any identifying information of a user or entity, such as, without limitation, name, telephone (“phone”) number, electronic mail (“email”) address, or instant messaging (“IM”) handle.

The term “identity,” as used herein, generally refers to any identifying information of or related to a user, such as one or more of name (first and/or last name), address (street address, city, state, zip code), phone number, government identification number (e.g., social security number), email address and IM handle.

The term “common contact,” as used herein, generally refers to a person or entity that is in common between two users. A common contact can be identified using contact information in at least two contacts lists (or databases). In an example, a first user and a second user each having at least two identifying information of a third user in their contacts lists have the third user as a common contact. In some cases, however, single contact information can be used to identify a common contact if the information is deemed unique.

The term “linked,” as used herein, generally means that a first user knows a second user. The second user can be an individual or entity. In an example, the first user is linked to the second user if the second user has contact information of the first user, and vice versa. In a further example, the first user is linked to the second user if the first user and second user are members of the same organization. In a further example, the first user is linked to the second user if the first user and second user indicate a desire to be linked.

The term “affiliate entity” (or “affiliate network”), as used herein, generally refers to a group or organization (e.g., company, social networking group) that includes one or more users. In an example, a first user is in an affiliate network of a second user if the first user and second user work for the same company. In some cases, affiliate networks can be identified by group codes. In another example, a first user is in an affiliate network of a second user if they share common contacts or, as an alternative, if the first user is in a contact list of the second user (or vice versa).

The term “configured to,” as used herein, can refer to a system or device that is programmed to perform certain functions. Such system or device can be programmed to perform other functions. In an example, a system configured to bring a first user in communication with another user is programmed to bring the first user in communication with that user.

The term “in a user's phone”, as used herein, generally refers to a contact record residing in the contact record database of the user, and can include contact record databases which are stored on a smart phone but also includes contact record databases stored on computers, “in the cloud”, or anywhere that is personally accessible by the user.

The term “electronic notification,” as used herein, generally refers to a visual and/or auditory notification provided to a user, such as by way of an electronic device of the user. Examples of electronic notifications include, without limitation, an electronic mail (email), push notification, instant message or text message (e.g., short message service (SMS) text or multimedia messaging service (MMS) text). An electronic notification can be an electronic communication, such as an email. An electronic notification can be displayed on a user interface of an electronic device of a user, such as, for example, in list form.

Systems and methods provided herein enable a requester to meet, such as by way of referral or introduction, a target through a facilitator. The facilitator may be a user in a group or organization (e.g., company, group) of the requester. In some cases, the requester does not know the identity of the facilitator, but is associated with the facilitator by virtue of belonging to same group or organization as the facilitator. The requester may know the relationship source of the facilitator, such as company, group, friend, personal network. In other cases, the requester does not know the identity of the facilitator and does not necessarily belong to the same group or organization as the facilitator. Systems and methods provided herein provide a degree of trust (or confidence) in a facilitator introducing a requester to a target, and a degree of trust in a requester getting an introduction from a facilitator in the requester's network. A facilitator that does not want to introduce a requester to a target does not have to authorize or facilitate the introduction. In some embodiments, the system does not reveal the identity of the facilitator to the requester, in which case the requester does not know which facilitator denied the requester the introduction to the target.

In some situations, a request from a requester is parsed out into groups based on relationship sources, such as relationships to the requestor. In some cases, the requestor will see the groups that have the target as someone they know, and will also know the number of people that will receive the request for introduction. The number can be grouped by organization. For instance, a requester can be provided with the number of targets in a given organization that will each receive a request. A requester can, in some cases, delete a specific group in their introduction request such that targets in the group (e.g., the co workers of the same company as the requestor) will not receive an introduction request.

### Methods and Systems for Facilitating Introductions

An aspect of the present disclosure provides systems and methods for bringing users in contact with one another by way of a common user, such as by facilitating introductions among users. In some embodiments, a requester can be introduced to a target through a facilitator, the identity of the facilitator being hidden from the requester (i.e., the facilitator is anonymous with respect to the requester).

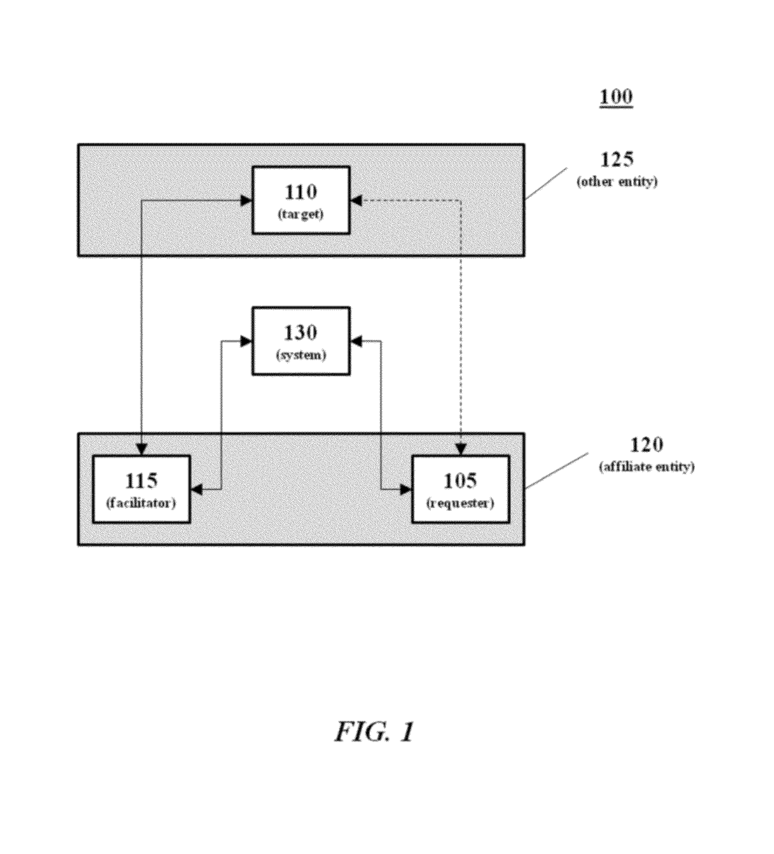

FIG. 1 shows a workflow 100 for bringing a requester 105 in contact with a target 110 through a facilitator 115, in accordance with an embodiment of the present disclosure. The facilitator 115 knows the identity of the target 110. In some situations, the facilitator 115 is anonymous with respect to the requester 105—that is, the requester 105 does not know the identity of the facilitator 115, but the requester 105 knows that a contact among the requester's 105 contacts has a connection to the target 110.

The requester 105 and facilitator 115 can be directly or indirectly linked to one another. Direct linkage can be through a contact list of the requester 105 or target 110. Indirect linkage can be through an organization of the requester 105 and facilitator 115. In some embodiments, the requester 105 and facilitator 115 belong to an affiliate entity 120 (e.g., company, group, friends) having one or more other users. In an example, the affiliate entity 120 is a company. In some cases, the target 110 belongs to a second organization 125 that is different than the affiliate entity 120. Alternatively, the target 110 does not belong to any organization.

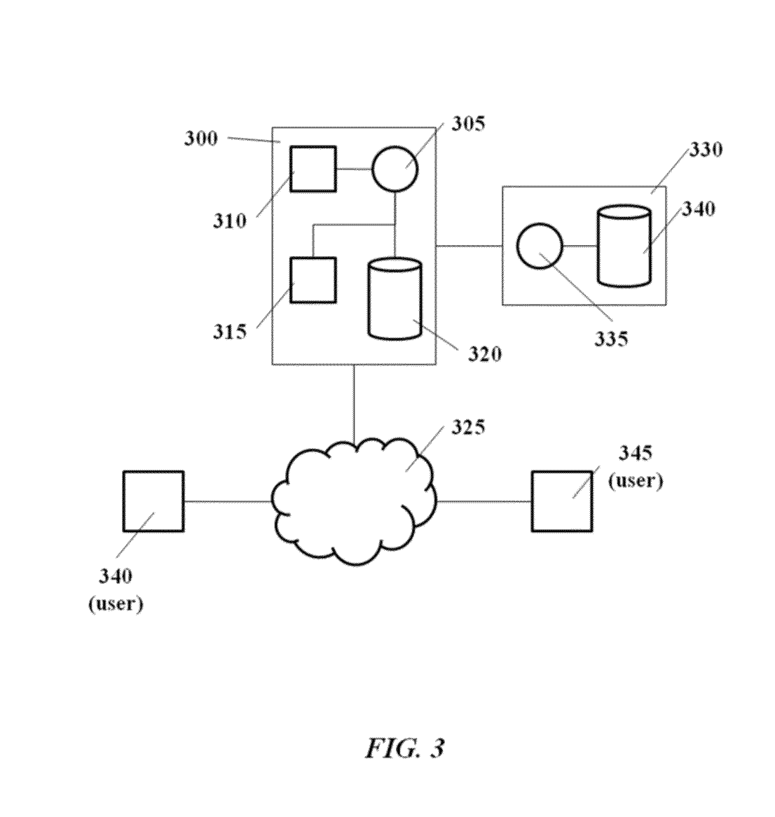

In some situations, the requester 105 and the facilitator 115 are members of a system that manages user introductions (see, e.g., FIG. 3). The target 110 may or may not be a member or user of the system.

The target 110 and facilitator 115 can be directly or indirectly linked to one another. In some cases, the target 110 is identified in a contact list (or database) of the facilitator 115, in which case the linkage between the target 110 and facilitator 115 is direct.

The workflow 100 can be facilitated by a computer system (“system”) 130 in communication with each of the requester 105 and facilitator 115. In some cases, the computer system 130 is also in communication with the target 110. The system 130 can facilitate an introduction between the requester 105 and target 110, such as a communication (e.g., email) introducing the requester 105 to the target 110 (e.g., “Hi Tom, meet Barry, an employee of Acme Co. Barry would like to get in touch with you.”). The introduction can be by way of an electronic mail (“email”), text message (e.g., short message service (SMS) text or multimedia messaging service (MMS) text), instant message (IM), or phone call. Alternatively, the facilitator 115 can introduce the requester 105 to the target 110.

In some embodiments, the system 130 enables the requester 105 (requester) to request an introduction to the target 110 (target) through the facilitator 115 (facilitator) only if the requester 105 is in an affiliate network of the facilitator 115. The affiliate network can be a business or social group or organization of the requester 105 and the facilitator 115.

In some situations, the system 130 brings the requester 105 in contact with the target 110 only if the facilitator 115 has granted the system 130 permission to make the introduction. In an example, the system 130 transmits to the facilitator 115 a communication (e.g., email, text message, or instant message) requesting that the facilitator 115 authorize the system 130 to introduce the requester 105 to the target 110. Upon the facilitator 115 authorizing the system 130 to introduce the requester 105 to the target 110, the system 130 brings the requester 105 and target 110 in contact with one another. In an example, the system 130 transmits the requester 105 the contact information of the target and/or the system 130 transmits the target 110 the contact information of the requester 105. In another example, the system 130 sends the target 110 a message in which the requester 105 is copied, and introducing the requester 105 to the target 110 (e.g., “Hi Jack, Paul has requested an introduction to you. By way of email, please meet Paul.”). In some cases, the target 110 and facilitator 115 are within one degree of separation from one another—that is, the target 110 knows the facilitator 115. In other cases, however, the target 110 and facilitator 115 are within 2, 3, 4, 5, or 6 degrees of separation from one another, as may be the case through one or more other users.

As an alternative, the facilitator 115 can introduce the requester 105 to the target 110. In an example, upon the facilitator 115 authorizing the system 130 to introduce the requester 105 to the target, the system requests that the facilitator contact the requester 105 to initiate introductions between the requester 105 and the target 110. In another example, upon the facilitator 115 authorizing the system, the system reveals the identity of the facilitator 115 to the requester, and the requester 105 can subsequently contact the facilitator 115 to request an introduction to the target 110. The system may not automatically introduce the requester 105 to the target 110, but may bring the requester 105 in communication with the facilitator 115.

In some embodiments, the system 130 brings the requester 105 in contact with the target 110 by searching a contact database having a contact list of the facilitator 115. The requester 105 and facilitator 115 belong to the same organization. The system 130 determines whether the facilitator 115 knows the target 110. This may include the system 130 determining whether the facilitator 115 is within one degree of separation from the target 110, such as if the target 110 is identified in a contacts database of the facilitator 115. If the system determines that the facilitator 115 knows or is otherwise one degree removed from the target 110, the system 130 provides the requester 105 the option to request an introduction to the target 110.

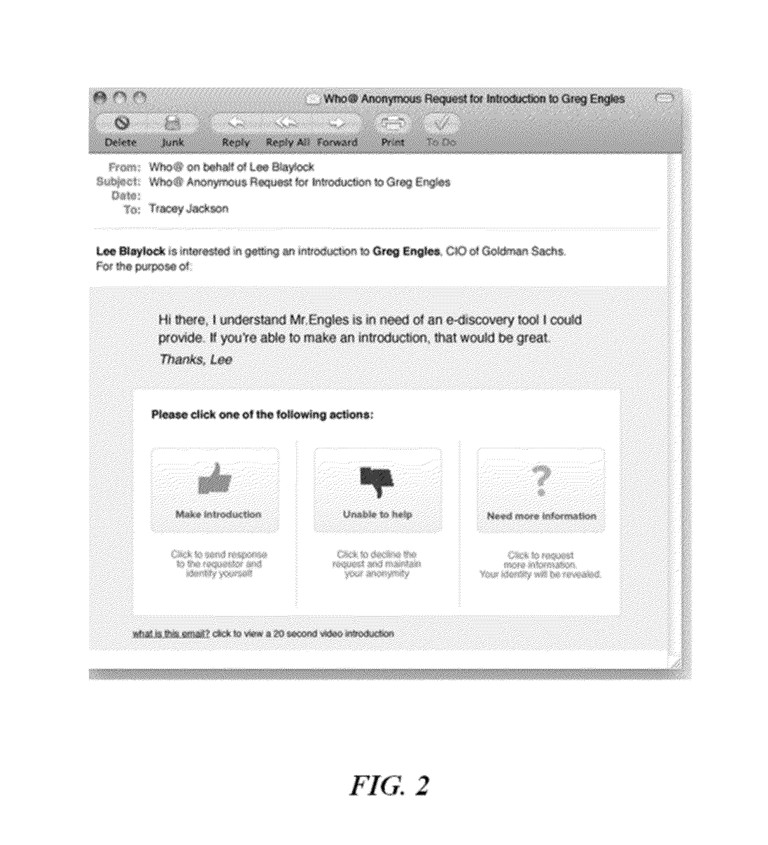

In some cases, the system 130 sends the facilitator 115 a communication indicating that the requester 105 has requested an introduction to the target 110. The communication can be provided by way of a graphical user interface (GUI) of a computer system of the facilitator 115, such as an electronic device. In an example, the electronic device is a mobile device, such as, e.g., a Smart phone (e.g., Apple® iPhone, Android-enabled device). FIG. 2 illustrates an exemplary electronic communication from the system 130 to a facilitator (“Tracey Jackson”). In the illustrated example, the facilitator (“Tracey Jackson”) has received an electronic mail (email) from the system 130 indicating that the requester (“Lee Blaylock”) has requested an introduction to the target (“Greg Engles”). The facilitator may elect to introduce the requester to the target (“Make introduction”) or elect to not introduce the requester to the target (“Unable to help”). In the illustrated example, the facilitator is presented with a textual message from the requester providing an explanation as to the need for the requested introduction.

In an example, the system 130 facilitates the introduction of the requester 105 to the target 110 through the facilitator 115. The requester 105 initially does not know the identity or have any contact information of the target 110, and the requester 105 does not know the identity or have any contact information of the facilitator 115. The system 130 sends the facilitator 115 a communication asking the facilitator 115 whether the facilitator authorizes the system 130 to facilitate the introduction of the requester 105 to the target 110. If the facilitator 115 authorizes the system 130, the system 130 facilitates the introduction. Absent such authorization from the facilitator 115, the system 130 does not introduce the requester 105 to the target 115, and the identity or contact information of the target 110 is not revealed to the requester 105. The identity of the facilitator 115, including the contact information of the facilitator 115, is not revealed to the requester, but in some cases the facilitator 115 may request that the system 130 reveal the facilitator's 115 identity or contact information to the requester 105.

In some cases, the system 130 maintains a record of introduction or referral requests that the facilitator 115 has authorized (or made manually) and requests that the facilitator 115 has declined. The record can be used by the system to offer rewards (e.g., rewards for authorizing introductions) and perform various analyses, such as analyzing authorized and declined requests by company and/or geography. In an embodiment, the system 130 analyzes the log of accepted and rejected introduction requests and uses the patterns of accepted and rejected requests to predict which facilitators 115 are more likely to provide successful introductions between requester 105 and target 110.

In some embodiments, if the requester 105, target 110 and facilitator 115 belong to the same affiliate entity 120 (e.g., company or group), then the system can reveal company contact information (e.g., work email and work phone) to the requester 105 without requiring an introduction from the facilitator 115. Since each party belongs to the same entity 120, there is a certain amount of trust between the parties. The system 130 determines that requester 105, facilitator 115, and target 110 belong to the same entity 120 and then the system 130 transmits contact information associated with target 110 to requester 105. In an embodiment, the system 130 transmits to the requester 105 the contact information for all targets 110 belonging to the entity 120, so that the requester 105 can view a directory of members of organization 120 and their contact information. In another embodiment, requester 105 can submit search requests to the system 130 and receive from the system 130 contact information for all targets 110 in entity 120 that match the search criteria.

The workflow 100 can be implemented by way of a user interface, such as a graphical user interface (GUI) as may be presented to a user (e.g., the requester 105) on an electronic display of the user. In some cases, the GUI is presented to the user on a Word Wide Web (“web”) interface of an electronic device of the user, such as a web browser. The electronic device can be a portable electronic device, such as a portable telephone, or a tablet or slate personal computer (e.g., Apple® iPad).

In some cases, GUI's are displayed to a user with the aid of a web interface, as can be implemented, for example, as a browser plug-in. A plug-in can include an application or module that is programmed to be executed by a computer processor (also “processor” herein) of a computer system of the user to provide various features described herein. The plug-in can be installed on various web browsers, such as, for example, a Firefox®, Internet Explorer®, Safari, Opera, or Google® Chrome, including portable or lite versions of such web browsers.

In an example, a browser plug-in is provided to enable a user to view potential targets at an organization of or related to a web site visited by the user (see, e.g., Example 4). The browser plug-in can provide a GUI that enables the computer system of the user to be operatively coupled to the system, such as the system 130 of FIG. 1. For example, if the user has visited Goldman Sachs' web site, the browser plug-in will enable the user to view a graphical item (e.g., icon) associated with the system, such as adjacent to the uniform resource locator (URL) bar of the browser. The user can subsequently click on the graphical item and view various contacts at Goldman Sachs in the user's affiliate network, such as by way of a facilitator (see FIG. 1). The user can subsequently request an introduction, such as by selecting a link to request an introduction to a contact.

The system can enable a user to view potential targets as the user is visiting a web site. A computer system of the user can include a module (e.g., by way of a plug-in) that is coupled to the system, which module can routinely monitor the content of a web site visited by the user for potential targets (e.g., targets at companies mentioned on web sites). In an example, a user visits a web site and views information related to a company. The company can be graphically or textually mentioned in content on the web site. The system identifies other users (facilitators) in the user's network that have relationships with various targets at the company. Each of the other users can be a facilitator, such as a facilitator that belongs to an organization (e.g., company or common group) of the user. In some cases, the system informs the user as to the number of facilitators that have a target at the company. The system can also inform the user as to the number of other targets that the user may be able to meet due to alignment of respective WishList needs and contacts (see below).

In some cases, a user can mouse or otherwise hover over a link displayed on a GUI of a computer system of the user, which can display content (e.g., a logo) that is related to the system. The user can then click or otherwise access the content and view material that provides target information at a company displayed on a web site visited by the user. In an example, the system provides a preferable target at the company, such as, for example, a target that may be of professional or social interest to the user.

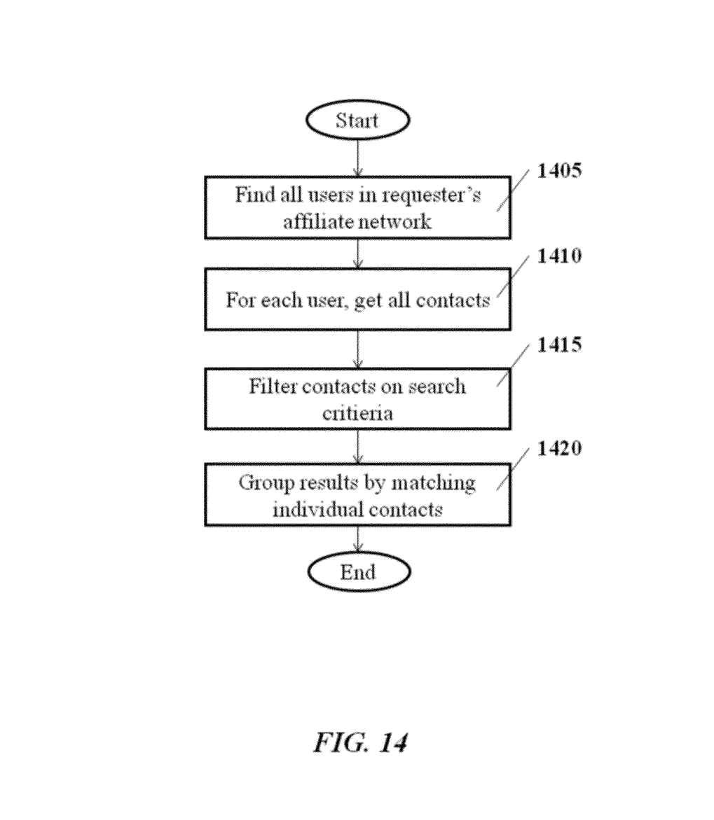

In some embodiments, the system 130 generates a list of contacts in a user's affiliate network. The list can aid in facilitating the introduction of a requester to a target through a facilitator at the requester's group or organization. FIG. 14 is a workflow showing the formation of contacts list, in accordance with an embodiment of the present disclosure. In a first step 1405, the system finds all users in a requester's affiliate network. Next, in a second step 1410, for each user found in the first step 1405, the system retrieves contact information. In a third step 1415, the system filters contacts on search criteria. In a fourth step 1420, the system groups results by matching individual contacts. A contact list thus provided can be used by the system 130 to enable a requester to find a target through a facilitator in the requester's affiliate network.

Systems provided herein, such as the system 130, can include various hardware and software. FIG. 3 shows a system 300 that can be used to implement methods provided herein. The system 300 includes a central processing unit (CPU) 305, memory (random-access memory and/or read-only memory) 310, a communications interface 315 and a data storage unit 320. The communications interface 315 can include a network interface for enabling a system to interact with a network 325, including other systems and subsystems, such as an intranet and/o the Internet, including the web. The communications interface 315 can be wired interface for wired communication with the network 325 and/or a wireless interface for wireless (or over-the-air) communication with the network 325. The system 300 is in communication with a secondary system 330, which can be a database or data warehouse. The secondary system 330 includes a CPU 335 and a data storage unit 340. In an example, the secondary system 330 is a database for storing user profiles and/or user contact information, such as the contact information of the first user 105, second user 110 and third user 115 of FIG. 1.

A data storage unit, such as the data storage unit 320, includes one or more hard disks and/or cache for data transfer and storage. A data storage unit may include one or more databases, such as a relational database. In some cases, the system further includes a data warehouse for storing information, such user information (e.g., profiles) and results. In some cases, the data warehouse resides on a computer system remote from the system. In some embodiments, the system may include a relational database and one or more servers, such as, for example, data servers. The system 300 can include one or more communication ports (COM PORTS), one or more input/output (I/O) modules, such as an I/O interface.

The system 300 can be in communication with one or more users through the network 325. This can enable the system 300 to communicate with the one or more users through an intranet or the Internet. In some cases, the network 325 can enable the system 300 to communicate with the cloud, which can include one or more computer systems for maintaining the network 325. In FIG. 3, the system 300 is in communication with users 340 and 345. In some cases, the system 300 is in communication with an electronic device of each user, such as a telephone, Smart phone (e.g., Apple® iPhone, HTC® phone, Blackberry® phone, Android® enabled phone), slate or tablet personal computer (e.g., Apple® iPad, Samsung® Galaxy Tab), a PC (e.g., Apple MacBook Pro), a mainframe, a server, or other electronic device having a CPU or other logic and a communications interface for enabling communication with the system 300. The electronic device can be a mobile device (e.g., Smart phone). The electronic device of a user can be coupled to the system 300 through the network 325.

The system 300 can be configured for data mining and extract, transform and load (ETL) operations, which may permit the system to load information from a raw data source (or mined data) into a data warehouse. The data warehouse can be configured for use with a business intelligence system (e.g., Microstrategy®, Business Objects®).

The system 300 can be configured to enable a user to create, update and/or edit a profile of the user. In some embodiments, a user creates an account (or profile) on the system, such as the system 300 of FIG. 3. Once the account has been created, the system can validate the account, including the user's contact information, such as, for example, by sending an email to an email address provided by the user and requesting return confirmation from the user, such as by clicking on a link provided in the email that transmits a return confirmation to the system. Next, the user uploads the contacts of the user to the system. In some cases, the user authorizes the system to automatically upload the contacts to the system. The system can store the contact information on a database dedicated to the user, or a database of the user's organization (e.g., company). Next, the system performs a search of each contact (i.e., other users) of the user to determine which contact has an account or profile on the system. In some cases, the system then establishes a virtual connection between the user and the contact. The system can then search for other users that the user may want to meet, such as an employee at a company that the user has a connection to through a facilitator in an organization of the user, and present such other users to the user. The user can filter the user's relationships to targets in accordance with various filtering criteria, such as location and/or company.

In some embodiments, the system collects user contact information from an email server of the organization of the user, and/or a contacts database of the user, such as a contacts database on an electronic device of the user (e.g., a contacts list on the user's computer or smart phone), an email or social networking account of the user (e.g., the user's Google+profile, Facebook profile, Gmail account, or Yahoo mail), or an email account of the user's organization (e.g., a Microsoft® Exchange® account).

In some embodiments, the system analyzes the contact information for a contact and determines if that contact corresponds to the same person as another contact that exists in the system. The system compares the identifying information for the two contacts and determines a degree of correspondence and if the two contacts are substantially similar then the system will determine that the two contacts correspond to the same person. For example, if contact A has a last name of “Martin”, an email address of “rick.martin@BASE.com”, and a phone number of “212-555-1212”, and if contact B has a last name of “Martin”, and email address of “rick.martin@BASE.com”, and a phone number of “972-888-1000”, then the system may conclude that the contact A and contact B are the same person since they have the same last name and email address even though they have a different phone number. In an embodiment, the system assigns different weights to the various pieces of contact information and adds the weights together for each piece of contact information that matches to determine a degree of correspondence between two contacts. The system can employ a root resolving process, such as a root resolving process described elsewhere herein (see below), to determine contacts that correspond to the same person or entity.

In some cases, during the registration process with the system, which can include creating a user profile, a user can upload contacts from an electronic device of the user, such as a Smart phone. Prior to searching for other users, the user authenticates the user's identity, such as by authenticating an organization (e.g., company) email address of the user (e.g., a Microsoft® Exchange® account), or by authenticating a webmail (e.g., Gmail®) account.

In some situations, when a user uploads contacts, the system can permit the user to invite the user's contacts to the system. In an example, the system only offers to invite contacts that work at the same company. In another example, the system excludes contacts that are already users of the system.

In some embodiments, the contact information of the user will remain hidden from other users. The system can present potential targets to the user, which may be provided by way of a facilitator (see above). The targets can be presented to the user via a web interface or a user interface on an electronic device of the user (e.g., a notification on a browser of the user) or by direct communication, such as an email or text message. The electronic device can be a portable computer, tablet (e.g., iPad) or smart phone (e.g., iPhone).

A requester can view one or more targets on the system (e.g., the system 300 of FIG. 3), such as by accessing a contacts database. The system in some cases can inform the requester as to whether a contact of the requester has a profile (or account) on the system. If a contact does not have an account on the system, the system can provide the requester the option to send the contact an invitation to register an account with the system. Once the contact registers an account with the system, the system can pair the requester and the newly-registered contact. The newly-registered contact can be a facilitator.

In some embodiments, a requester can search for contacts in any affiliate network, such as a network associated with the requester's company, a network associated with a requester's friended accounts or a network associated with a group or account. An affiliate network can be, for example, a company network or social networking group. A requester can also search for targets by viewing the requester's contacts to determine potential targets. In some cases, the identity of the facilitator will remain hidden from the requester, but the facilitator in some cases can be revealed to the requester upon authorization from the facilitator. In some situations, a requester can search for targets by conducting a search on the basis of one or more of the requester's contacts, networks, groups, job title, name, area code, location (e.g., geolocation), hobbies, interests (e.g., sports interests, social interests, entertainment interests), school (e.g., college), company, affiliate company, and company of interest (e.g., the user works for Google but wants an introduction to a target working at Microsoft).

In some cases, the system does not display the contact information of a target to a requester. In other cases, the system provides the requester information that may be sufficient to partially identify a target, such as, for example, the first name, last name and organizational role and/or title (e.g., “Executive,” “Manager,” “Project manager,” or “Engineer”) of the target. The system may also provide one or more affiliate networks the requester is part of, such as through another contact, company, group or location. The user can subsequently request an introduction from a facilitator to the target to communicate with the target. The facilitator can agree to make an introduction via phone, email or any other communication protocol, such as instant messaging.

In some cases, the facilitator can refuse the request to introduce the user to the target. The identity of the facilitator in such a case can remain hidden from the user such that the user does not know which facilitator refused the request. In some cases, the requester may not receive a communication from the system indicating that the request for an introduction has been refused, and will not be able to determine which other user served as the facilitator. This advantageously reduces, if not eliminates, any social pressure associated with a facilitator making an introduction—the facilitator is not compelled to make an introduction that the facilitator is not comfortable making. In some cases, the system permits a requester to make a finite number of requests for an introduction, such as 1, 2, 3, 4, 5, 6, 7, 8, 9, or 10 requests. In some cases, the requestor will receive a communication from the system indicating that a request was refused, but the system does not identify the facilitator.

Aspects of systems and methods provided herein, such as the system 130 of FIG. 1 or the system 300 of FIG. 3, can be embodied in programming. Various aspects of the technology may be thought of as “products” or “articles of manufacture” typically in the form of executable code and/or associated data that is carried on or embodied in a type of machine readable medium. “Storage” type media can include any or all of the tangible memory of the computers, processors or the like, or associated modules thereof, such as various semiconductor memories, tape drives, disk drives and the like, which can provide non-transitory storage at any time for the software programming. All or portions of the software can be at times communicated through the Internet or various other telecommunication networks, such as an intranet. Such communications, for example, can enable loading of the software from one computer or processor into another, for example, from a management server or host computer into the computer platform of an application server. Another type of media that can bear the software elements includes optical, electrical and/or electromagnetic waves, such as used across physical interfaces between local devices, through wired and optical landline networks and various over-the-air (or wireless) links. The physical elements that carry such waves, such as wired or wireless links, optical links or the like, also can be considered as media bearing the software. As used herein, unless restricted to non-transitory, tangible “storage” media, terms such as computer or machine “readable medium” refer to any medium that participates in providing instructions to a processor for execution.

A machine readable medium, such as computer-executable code, can take many forms, including, but not limited to, a tangible storage medium, a carrier wave medium or physical transmission medium. Non-volatile storage media include, for example, optical or magnetic disks, such as any of the storage devices in any computer(s) or the like, such as can be used to implement systems and methods shown in the drawings. Volatile storage media include dynamic memory, such as main memory of such a computer platform or system. Tangible transmission media include coaxial cables (e.g., copper wire) and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some embodiments, the system 300 is configured to communicate with one or more remote devices, such as a remote electronic device. Such remote connection is facilitated using the communications interface. In some situations, the system 300 presents information to (or requests information from) a user by way of a user interface on an electronic device of the user. The user interface can be a graphical user interface (GUI). In some cases, the GUI operates on an electronic device of the user, such as a portable electronic device (e.g., mobile phone, Smart phone). The electronic device can include an operating system for executing software and the graphical user interface of the electronic device.

Systems provided herein can be programmed for data mining. In some cases, a system mines for data (i.e., electronic data) across a network, such as an intranet and/or the Internet, for information to include in a user's profile. Such information can be of or related to other users and/or companies or organizations, such as businesses of interest to the user. The system can mine for data based on the users social and/or professional interests. In an example, the system mines for information of or related to a social networking company (e.g., Facebook) for a user employed at a software company that is different from the social network company. System provided herein can provide predictive analytical data based on a user's introduction history, such as information relating to requests that a facilitator has authorized or denied, or the requests that a requester has made. Other sample factors include, without limitation, whether the requester and/or the facilitator have the other's contact information in their respective database; whether the requester and/or facilitator work in the same company, industry, geography, or have similar titles; whether the facilitator has accepted or denied requests to the target; and how well does the facilitator know the requester to make the introduction after multiple and independent requests from the requester for the introduction. The weight of the facilitator being able to help with an introduction to the target may be increased or reduced (in relation to another facilitator, for example) based on such factors.

In some embodiments, systems for facilitating user introductions integrate a user's contact information with broad industry data sources, such as Standard & Poor's, Hoovers, Lexus Nexus, or industry/personal specific data sources such as Reed Business Information, Costar, Data.gov or Federal Election Commission data or other companies that provide corporate and personal data. Such integration can enable data mining to augment or otherwise supplement the profile of the target, which can allow the user to find new opportunities that were previously unavailable or otherwise not readily accessible to the user. The integration can aid users in identifying more relevant relationships to build that can help the requester achieve their business objectives.

### User WishLists

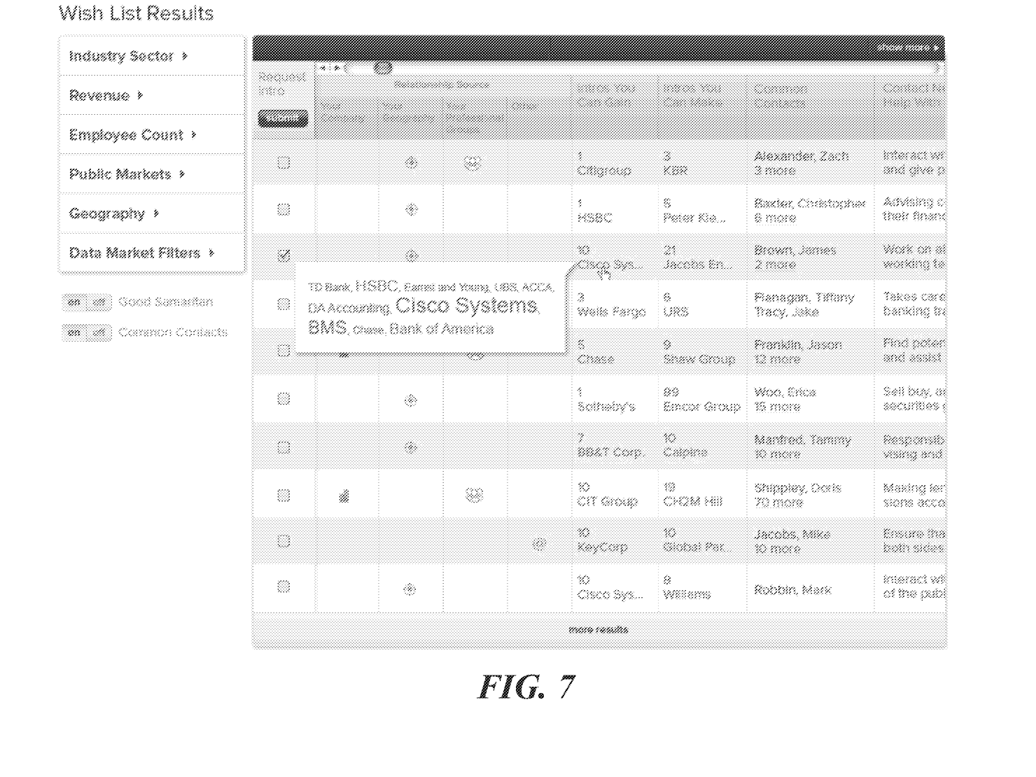

Another aspect of the present disclosure provides user WishLists (also “wish lists” herein). A wish list can be implemented with the aid of systems provided herein, such as the system 130 of FIG. 1. Wish lists enable a user (requester) to provide the system a list of specific names of companies, profiles of the types of companies (using the DataMarket to help filter those company profiles), titles of employees at those companies or even specific names of employees at those companies one or more targets that the user wishes to meet or be introduced to, such as through a facilitator. WishLists can facilitate future introductions that may presently be unavailable. Based on matching criteria, the system can then introduce the requester to the target with the aid of the facilitator's connection to the target. Such introduction can be made at a later point in time, such as after the user creates the WishList, or several concurrent WishLists. A WishList may be used for searches directed at targets inside or outside of a requester's affiliate network. FIGS. 7-10 and FIGS. 23-24 show examples of WishList results and settings.

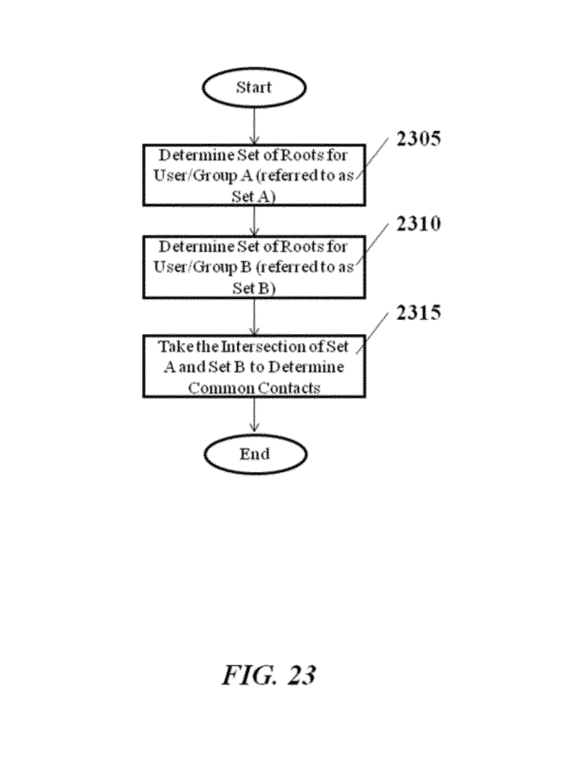

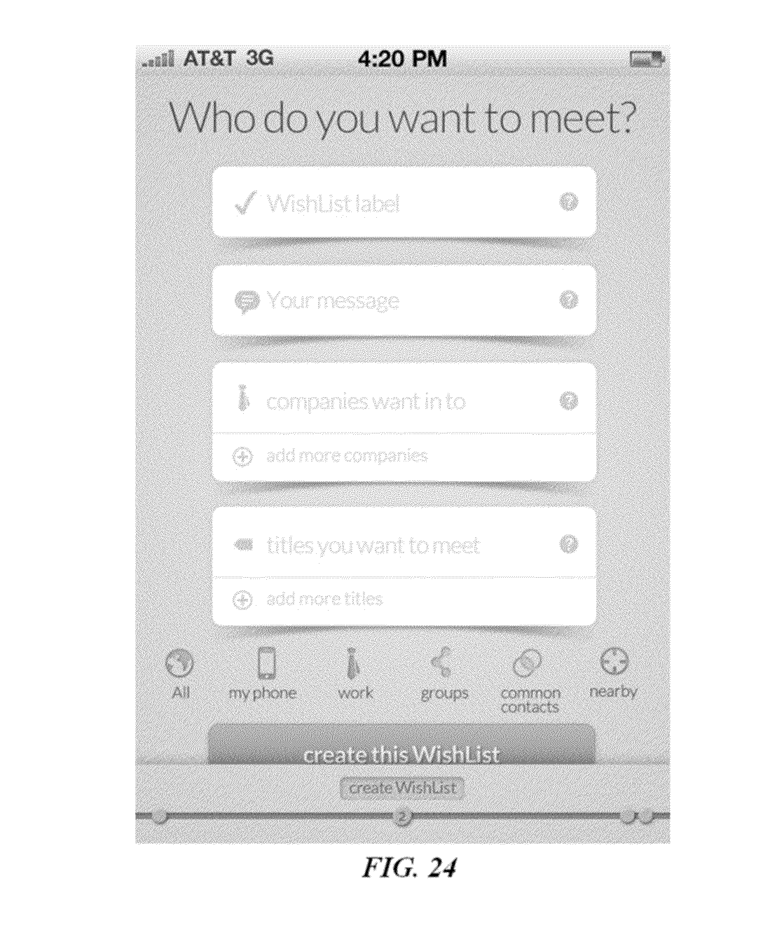

Matching criteria can include the requester's degree of separation from the facilitator, or whether the requester has a connection to a target that the facilitator may be interested in. In some cases, the system introduces the requester to the target if the requester has a connection to another target on the facilitator's WishList. To enable Trust or Network filters (with both terms being interchangeable for this purpose) The user can enable a setting to say, for example, that they only want to play the WishList with people who are already in each respective user's phone, and/or in their company, and/or a common group both members have opted into and/or use location awareness to only want to play the WishList with people in close proximity if being used on their phone at a trade show or other meet up. In the example of FIGS. 23 and 24, the Trust or Network filters are implemented as icon buttons that when tapped toggle on and off, enabling and disabling the filter for the current WishList.

For example, User A wishes to be introduced to User B. User C is in the same organization as User A. User B is included in a contacts database of User C. User C wishes to be introduced to User D, who is included in a contacts database of User A. The system introduces User A to User B in exchange for the possibility (e.g., future possibility) of introducing User C to User D. The system can request authorization from each of User A and User C to make the introduction. In some cases, User C permits the system to introduce User A to User B, but may not expect a return introduction to User D.

In some embodiments, a user provides the system a search term for use in searching a database of the system for other users. The search term can include one or more identifying information of or related to other users, such as names, titles, location, demographic information, firmagraphic information and/or companies of other users. The system then provides the user a list of other users that the user may be interested in, such as through a facilitator. In some situations, the user may not be able to get an introduction to another user revealed by the search but may add this user to the user's WishList for a future introduction, such as if a facilitator emerges in the user's network that can facilitate the introduction. The system can enable the user to filter search results, such as by location, relative ranking, name, title, and/or company. In some cases, the system enables a user to filter the results such that the results displayed are of other users having common contact with the first user (people both users know in common). This can enable the user to request a reference on a potentially desired target, thereby providing a level (or degree) of trust.

In some situations, an electronic device of the user includes a geographic location (or geolocation) system, such as a global positioning system (GPS), which enables the system to provide a list of potential targets to the requester based on the geographic location and close proximity of the requester and the facilitator. In some cases, the system can allow a requester to limit the search results to targets or facilitators in close proximity to both the requester and the facilitator. The list of potential targets can be presented to the requester by way of a WishList, and the requester can select potential targets from the WishList.

In some situations, the system enables a first user having a WishList to meet a second user having a WishList. In some case, the system may request that the first and second users each authorize the system to generate a WishList. That is, in some cases a WishList may not be created until a user has authorized the system to generate the WishList.

In some cases, a user can use a WishList in order to extend a network of the user, which can aid the user in meeting targets. The WishList can include contacts in an affiliate network (e.g., groups, friended accounts, companies), as well as targets and facilitators who are outside the requester's network, yet pass one of the WishList filters such as Any Who@ member who has also filled out a WishList (where there are no other trust filters) in my phone, and/or company, and/or a groups the user has opted into and/or physical location based on the close proximity of two users. (see, e.g., FIG. 1). The system can allow a user to provide search criteria to find other users of personal, social and/or professional interest, such as users who can who can help the user achieve one or more goals or objectives of the user. The search criteria can include a company, uniform resource location (URL), location (e.g., city, state, country), company demographics, and/or industry sector. In some cases, upon the user providing search criteria to the system, the system automatically searches for and provides results if one or more users fitting the search criteria are found by the system.

In some situations, a user can have one or more WishLists. For instance, a user can have a WishList of targets of social interest to the user. In another example, a user has a WishList of targets of professional (or work-related) interest to the user. Such WishLists can be included in a profile of the user.

In some embodiments, the system communicates with a geolocation sub-system or module to provide location-based services to a user. The system can enable the user to input target companies or users of interest, and the system can conduct a search within a geographic location at, in proximity to, or otherwise designated by the user to determine whether any potential targets are present at the geographic location. The user in some cases can specify a search radius. For example, the system can enable the user to search for a target working at Microsoft who is attending an event in Las Vegas while the user is visiting the same event in Las Vegas.

In some cases, the system can enable the user to turn location-based services on and off according to calendar entries. This is a setting the user can alter that will allow the service to be automatically turned on and off during a period that user has on the user's calendar as a meeting or appointment. For example, if the user has a calendar entry for a given meeting, the system will automatically turn location services off and on based on the approximate time when the calendar event is set to begin and set to terminate, respectively. This feature can aid in maximizing battery life of an electronic device in communication with the system.

In some embodiments, a WishList is presented to the user with the aid of a user interface, such as a graphical user interface (GUI) of a computer system of the user. The user interface can display the number of companies or individuals (targets) to which a particular contact (facilitator) can provide an introduction, the number of targets to which the facilitator can introduce the requester, a summary of targets of interest to the facilitator, and an indication of the number of shared (or common) contacts. In some embodiments, the WishList is ordered according to how much value a facilitator can provide to the user. The system determines the value that a facilitator can provide by incorporating the number of companies of interest to the user, the number of targets of interest, the trust/network filters that both members have set and the number of common contacts into an algorithm that produces a relative value for a facilitator. In a WishList, users can be requesters and facilitators. That is, in some cases a user can be a requester, though in other cases the same user can be a facilitator.

In some embodiments, from the WishList a user (requester) can initiate an introduction request. This request is sent to all facilitators that are linked to a target. The facilitator will make an introduction between the requester and the target if a facilitator among the facilitators accepts the requester's request to make the introduction. If a facilitator agrees to make the introduction, then the requester will be notified and the facilitator will subsequently introduce the requester to the target. In some situations, however, the system can introduce the requester to the target.

In some embodiments, a system provides introduction credits, which may be used by users in future introduction requests. A facilitator can agree to introduce a requester to a target in exchange for the promise of a future introduction from the requester to a target selected by the facilitator. The promise can be implemented by way of an introduction credit to the facilitator, which the system can include in a profile of the facilitator.

In an example, a system facilitating introductions, such as the system 130 of FIG. 1, provides introduction credits to users. Introduction credits can be used by users in future introductions. For instance, a facilitator agrees to introduce a requester to a target in exchange for one or more introduction credits. In some cases, the number of introduction credits can be fixed or, alternatively, variable. For example, the number of introduction credits may be negotiated between the facilitator and the requester. Introduction credits can be determined, for instance, on the relative hierarchical rank of the target in relation to the requester. For example, a non-management level requester wanting an introduction to a management-level target may agree to provide more introduction credits to a facilitator than, for instance, if the requester wants an introduction to a non-management level target.

### Contact Data Integrity Management

Users typically change their contact information, such as upon changing their place of employment or residence. In some cases, a user may have old or otherwise outdated contact information of another user. For instance, a contact database of a first user may have outdated contact information of a second user, such as an old phone number, job title or email of the second user.

Another aspect of the present disclosure provides systems and methods for updating and managing user contact information. Such systems can be adapted for use with an organization, such as a company, having multiple users. In some embodiments, contact data integrity management systems and methods are provided for updating user contact information. Contact data integrity management can be implemented with the aid of systems provided herein, such as the system 130 of FIG. 1. Contact data integrity management (CDIM) allows the contact information of a first user to be updated in a contact database of a second user. In some cases, a first user provides old or otherwise outdated contact information to a CDIM system, such as an old business email addresses, and/or current contact information, such as current email addresses (e.g., business and/or webmail (e.g., Gmail)) and current phone numbers. For current contact information, the CDIM system then validates the information provided by the first user, such as by sending the first user a verification communication (e.g., email or text message). The CDIM system systematically monitors user contact information to determine whether such information is current. When the CDIM system determines that a second user has outdated contact information of the first user, the CDIM system informs the first user that the second user has the first user's outdated contact information. The CDIM system also provides the first user the option to update a contact database (e.g., contact list) of the second user with the first user's current contact information, or do nothing. If the first user does not choose to update the second user, the CDIM system may not notify the second user that the second user has the first user's outdated contact information.

In an example, a first user submits old business email addresses and the system, manually or systematically, verifies the old business email address. Any other user having the old business email addresses or a subset thereof shall have their contacts scanned. The system then notifies the first user if any of the other users have an old email address (or other contact information) of the user. The first user can then choose to permit the system to notify the others users, as selected by the first user, that they have old contact information of the first user. Should the first user decline to update any of the other users, such users will never know that the first user declined to permit the system to notify them.

In some situations, the system permits users to update all contact information, but the system would require users to validate (or verify) their identities using business contact information, such as a business email address.

In some embodiments, the system monitors a user's contact information. If a first user changes jobs, for instance, and has a new work address and phone number, the system detects other users who have the old contact information of the first user. However, the first user can decide which of the other users can see these changes and updates, such as by receiving an alert that the first user's contact information has changed. Alternatively, the first user can decide which of the other users can have the first user's contact information automatically updated by the system. In such a case, the system can inform other users selected by the first user for the update that the first user's contact information has changed and request permission from each of the other users for permission to make the update.

In an example, the first user provides the system former valid email addresses and current email addresses, both business and personal, including web mail (e.g., Gmail). The first user can also enter in one or more phone numbers and/or addresses of the first user, including current and/or former phone numbers and/or addresses. The system can subsequently contact the first user for verification, such as by requesting that the first user provide a verification code provided by the system. For instance, the system can send the first user a verification email at a current email address provided by the first user. The verification email can include a link to a web site, which can enable the first user to enter the verification code provided by the system. As an alternative, the system can send the first user a verification text message at a current phone number provided by the first user, and the first user can enter the verification code in a reply to the text message. Once the first user's contact information has been verified, the system reviews the old contact information for consistency with data the first user registered and validated. If the system finds that such information is consistent, then the old email address is “verified.” If not, then the old email address is not verified and the system can provide an exception report. The system can then implement a review of the first user's contact information, such as by an authorized first user (e.g., employee of an organization managing the system). Upon review, the first user's contact information can be flagged as verified or unverified. In some cases, the system can flag the first user's contact information as fraudulent.

In some cases, the system can notify the first user that a second user has outdated contact information of the first user. The system can provide the first user the opportunity to allow or disallow the system to update the second user's contact information of the first user with updated information. In some situations, if the first user does not want the second user's information of the first user to be updated, then the first user can disallow the system from making the update. However, if the first user does wish to have the second user's contact information of the first user updated, then the system can update the second user (e.g., a contacts database of the second user) with the first user's updated contact information. In some cases, the first user can request that the system notify the second user that the contact information has changed. The second user can then accept the changes, or not accept the change. In some cases, the second user can request that the first user be removed from the second user's contacts database. In some cases, if the first user decides not to notify the second user about the change or otherwise update the second user's contact information of the first user, the second user would be unaware that the first user has requested that the system not notify the second user or update the second user's contact information, and the contact information in the second user's contacts database would not be updated.

In some situations, the first user can select to automatically notify any other user where the first user has the accurate contact information for the second user, but the second user has outdated information for the first user. The first user will then receive a notice, such as a log, of the second users that were updated. This may be used, for instance, when the first user changes employment, as the first user may have accurate contact information for other users, and other users may not have the first user's updated contact information until the first user has notified them, such as with the aid of the system.

In some embodiments, a company data integrity management system retrieves user data (e.g., from MSFT Exchange silos) and performs an analysis of users that have old and other users that have current data about a contact within the company or outside the company. The system then suggests to the users who have old data that a certain percentage or number of their colleagues have the contact information. The system can review the point at which the contact information was created and last modified for each user having that contact, and can also determine and assign each user a measure (e.g., percentage) as to the degree of accuracy of the contact information (e.g., User A's contact information for User B is 80% accurate, and User C's contact information for User B is 60% accurate). The system can provide company employees the option to update their contacts databases with the contacts information, which can be information provided by a user having the most accurate information for the contact (e.g., User A's contact information for User B). The system thus leverages company contact assets to maintain updated contact information.

In some embodiments, the system notifies a second user of a change in a first user's contact information (e.g., new company address) if, for example, the first user leaves a company. In some cases, the second user will be automatically notified if the first user has enabled an automatic update feature of the system.

### Customer Relationship Management Deal Flow Analysis

Another aspect of the present disclosure provides systems and methods for enabling a user to compare successful or unsuccessful deals in a customer relationship management (CRM) module (or sub-system) with relationships established among contacts, and find potential business relationships through the user's contacts or affiliate network. The potential business relationships may be potential buyers of the user or products or services of the user's company. Such relationships can be established by way of contacts in a contacts database of the user. The contacts database can have one or more other users and contact information associated with each of the one or more other users. This can be implemented with the aid of systems provided herein, such as the system 130 of FIG. 1.

In some embodiments, the CRM module can allow a user to compare data in the CRM pipeline with both the data in an email server (e.g., the user's company email server, including employees' contacts that may be uploaded into the system 130) to see correlations and patterns of the types of relationships in the CRM against data in the email server, such as a Microsoft® Exchange email server. Furthermore, the CRM module can utilize the DataMarket's capability to compare the profile to other data, such as, e.g., characteristics such as company size, industry, number of employees, net income %, and outlier data, such as how much that company spends on advertising, real estate, average size of federal contracts awarded or any other data source that can be filtered from the DataMarket. The CRM module can then user cluster analysis and the data in the DataMarket to reveal patterns of the types of companies the user company is winning and suggest companies that meet the same profile that are in the user's email server and the prospective companies meeting that same pattern, to which the user can request an introduction with the aid of a WishList.

In some situations, a CRM module, which may be part of a larger system for managing user relationships, such as the system 130 of FIG. 1, enables a user to develop a pattern of successful and unsuccessful business deals. The CRM module or other analysis module can identify the types of leads and customers that result in successful deals and create a profile for them. The CRM module can then suggest new companies or entities not in the user's CRM module that meet a potentially successful profile. Such suggestion can be on the basis of user demographics, for example. In an example, the CRM module first suggests new companies or entities that are in the user's list of contacts (or company's email server, not just an individual user), such as another user that works for a target company or entity, and subsequently suggests new companies that the user can get an introduction to, such as through a facilitator (see FIG. 1). In some cases, the CRM module enables the user to add a target, such as a target company, to the user's WishList.

Systems provided herein, such as the system 130 of FIG. 1, can integrate into third-party CRM systems, such as Salesforce, SAP, Oracle or MSFT Dynamics. The system analyzes the sales cycles on various deals in the CRM system, using, for example, data analysis and machine learning techniques or algorithms. A pipeline analysis module can score various client profiles as more or less likely to result in sales. The system can leverage such information (e.g., score), providing potential client suggestions that can match the client profiles the deal flow analysis module identifies as most likely to result in sales. The system additionally allows a user to get an introduction to potential clients.

### Referrals

Systems and methods provided herein enable users to request or provide referrals, such as product or service referrals, while having a certain level of trust coupled with such referral. This enables a user to receive a referral while having some assurance that the referral is provided by a trusted source.

Some embodiments provide systems and methods for making user referrals. In some cases, the system enables a user to refer products or services to other users that are in the user's list of contacts. The system may also enable a user to share among the user's first level network connections, such as Facebook® connections. The system can enable the user to refer products or services to the user's contacts, which can include users that are within one degree of separation from the user. The referral can be by way of a rating system. The system can generate the contacts by searching a contacts database of the user (e.g., Microsoft® Exchange® contacts) and generating a list of users, and comparing the list of users to users that may have accounts on the system. The system can then create a contacts database for the user with any such users that may have accounts on the system, or to which an invitation to join the system has been sent. The user can then provide referrals to or request referrals from such users, such as product referrals or service referrals. In some cases, the system enables users within one degree of separation from one another to provide referrals by rating services and/or products (e.g., provide a 1 to 5 rating).

In some embodiments, a first user can indicate a willingness to make a referral for a particular service provider or merchant and/or service category to someone they are connected to via a social networking service (e.g., Facebook®) or have in their contacts. A second user can then request that the system provide referrals by service category, geography or by provider. The second user then receives a list of users that the second user knows (e.g., as determined by the second user's contacts) that can make a referral to that category and geography. The service provider can recruit or request given users to offer referrals for that service provider or merchant to their network of friends. The service provider can also add tags of the terms they want to be found by the user needing the referral and also define the geographic territory of their service capabilities.

Another aspect of the present disclosure provides systems and methods for users to provide and/or receive feedback from other users in their contacts databases and/or affiliate networks. Users can thus receive feedback or comments on, for example, products or services, from sources that users may trust.

In some cases, the system can include a plug-in or application programming interface (API) which can enable a first user to filter or otherwise selectively view comments for a particular service, event, or product provided by only users in the first users address book and/or affiliate network. In some cases, the system can provide this feature with the aid of a unique identifier (e.g., QR code). For example, the first user visits a restaurant or golf course and uses the identifier of the restaurant or golf course to view comments provided by the first user's contacts on a given web site, such as Yelp®.

In some embodiments, the system can enable a first user to use a plug-in or API to view or communicate with any other users that have common contacts with the first user. This can advantageously enable the first user to filter other users on web sites, such web sites of social interest to the user (e.g., social network sites, matchmaking sites). In an example, a user logs onto Match.com® to view potential matches. The user filters the potential matches to only users that have common contacts with the users. In some cases, the system enables the user to filter other users only if the web site as an API that enables the web site to interact with the system.

Another aspect of the present disclosure provides methods for managing deal flows to raise debt or equity capital or to sell a business, service or product. In some situations, the system matches a user's preferences as to potential deals (e.g., real estate deals) with deal parameters provided by a promoter. If the preferences match the parameters, the system provides the user deals that meet the user's preferences without revealing the identity of the user to the promoter. The system can provide the promoter the number of users that match given parameters. The user can identify, for example, the type of firm, qualified investor, non qualified investor, Family Office, Non Profit Foundation, REIT, iBank, a specific type of hedge fund, PE fund, angel investor, venture firm, sovereign wealth fund, insurance, private pension, and/or public pension, and the promoter can select the types of investors that can see the deal. The promoter can also show partial data. This can be focused on various types of equity and debt paper as that is a large and liquid market. The system can enable the user to determine whether the promoter is among the user's contacts, and if so, which of the user's contacts know the promoter. The user can then contact any Common Contacts to learn more about the promoter, and in some cases to get a referral or introduction to the promoter.

In some situations, any user or non user can suggest asset classes that a certain investor may be looking for, whether that investor knows or approves of it. The asset class may be of interest to a potential investor. In an example, User A knows that Company A is looking for an investor, which is information that is of value to User B, as user B may know an investor or may be interested in investing in Company A. User B can use the system to find users among User A's contacts, or users to which User B can be introduced to (targets), which may enable User B to reach a user within Company A that may enable User B to enter investment discussions.

### EXAMPLES

### Example 1

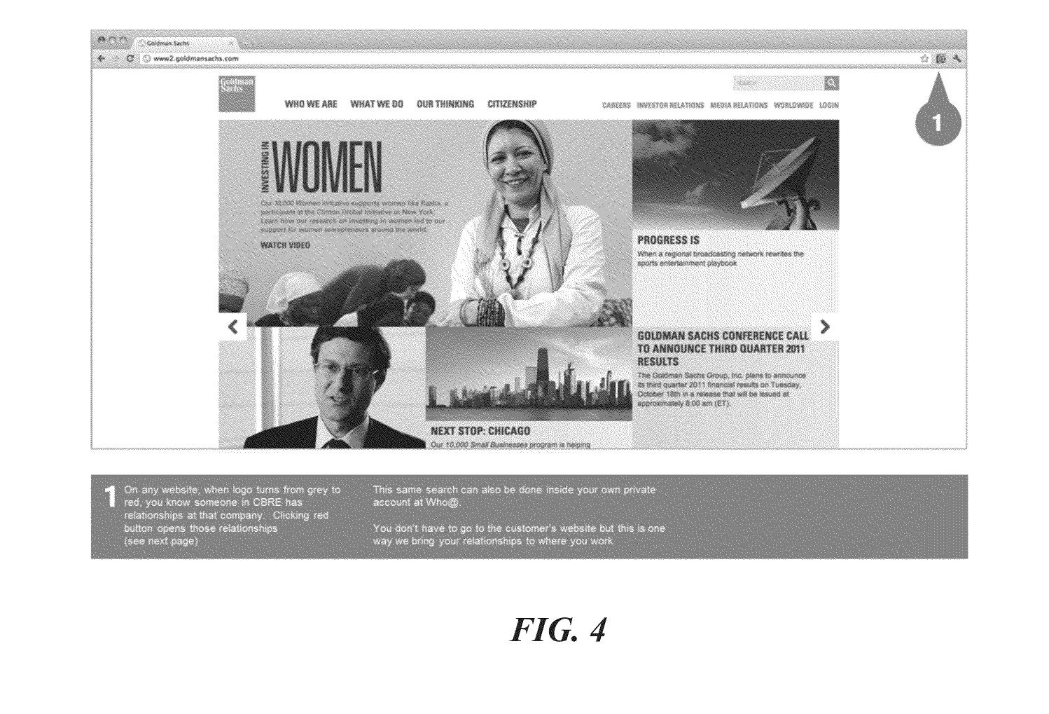

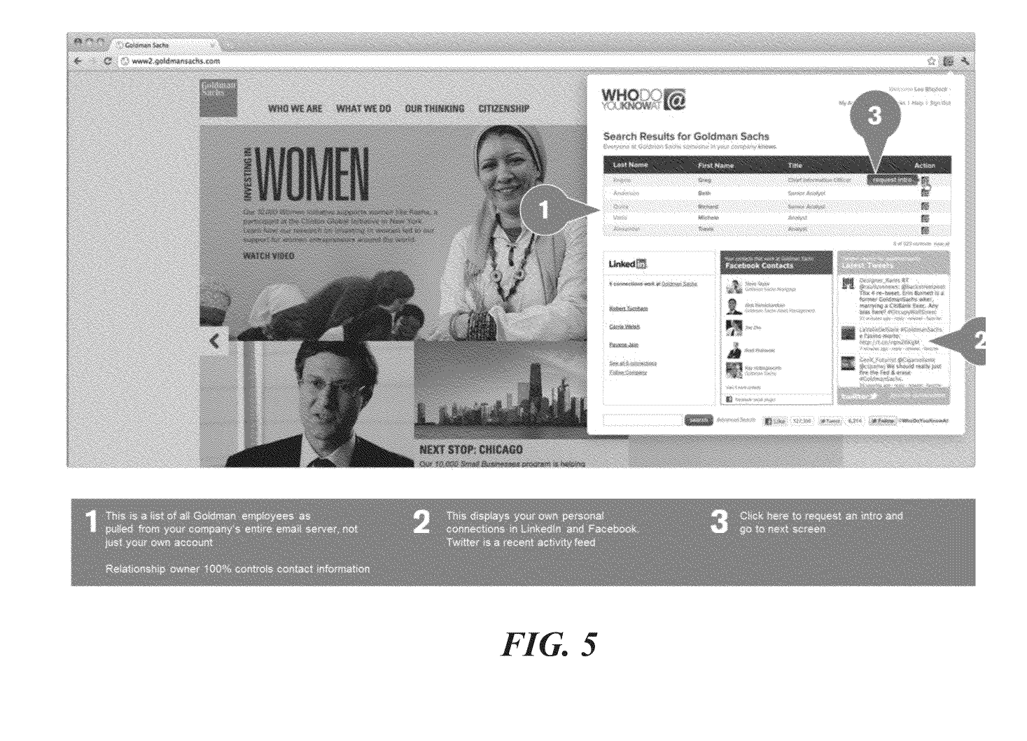

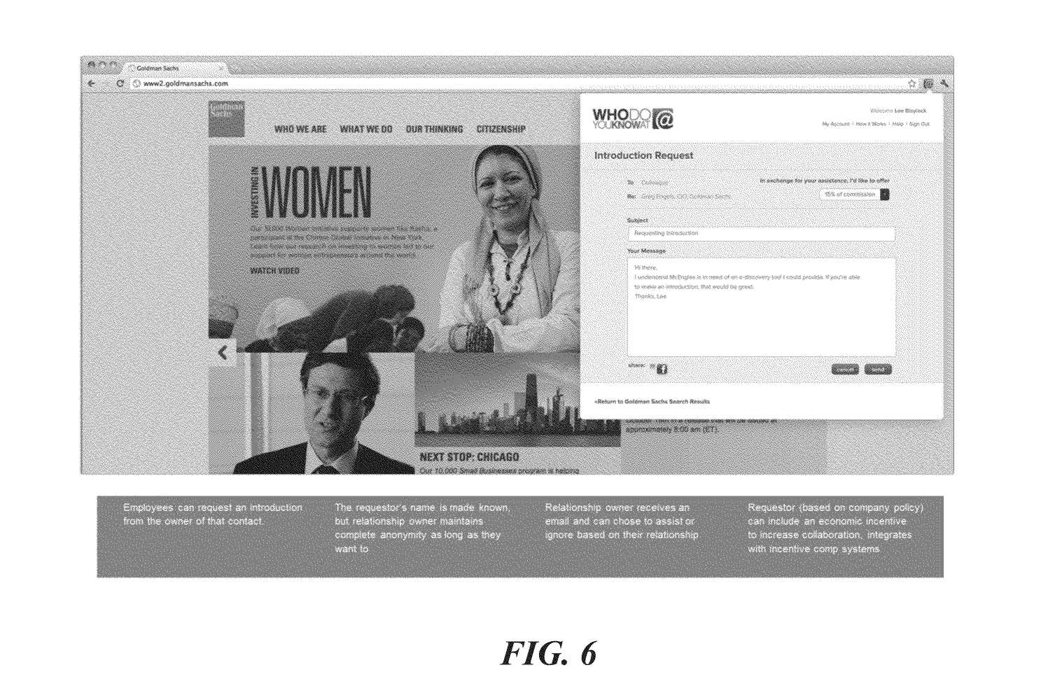

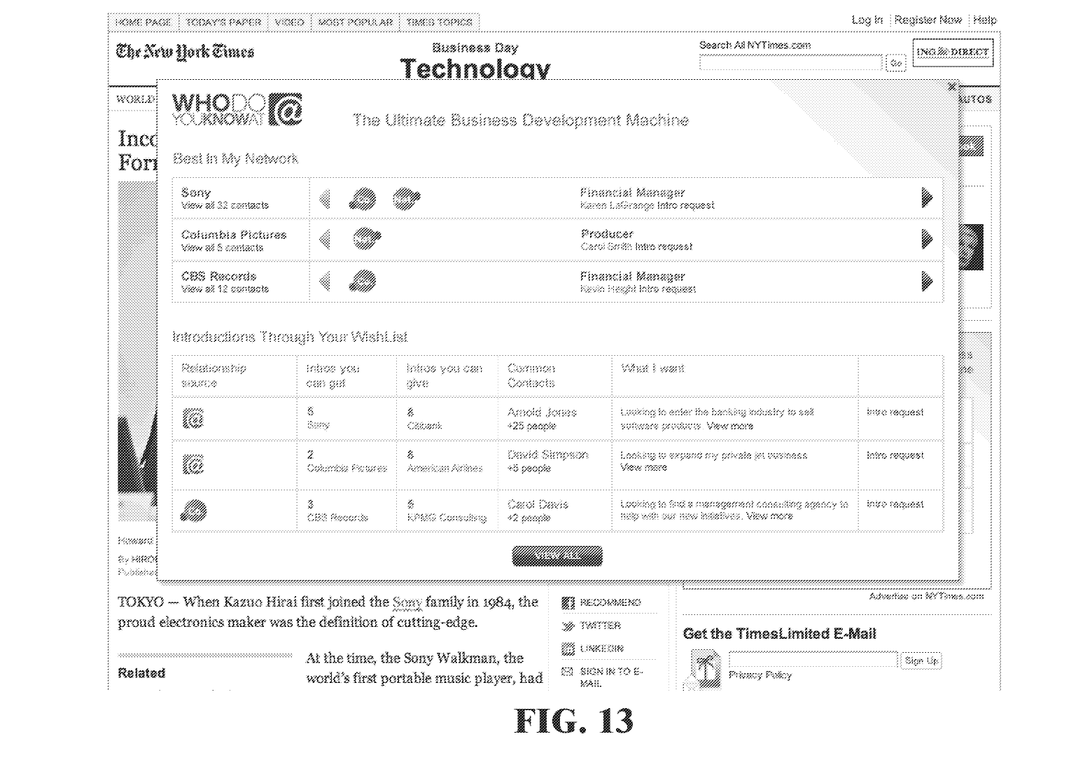

Systems and methods provided herein can be implemented with the aid of web browsers. FIG. 4 shows a web browser (“browser”) displaying web content of Goldman Sachs. The web browser has a system logo (arrow “1”) adjacent to a uniform resource locator (URL) bar of the browser. The logo changes color from gray to red upon a first user visiting a web site of a company in which a second user at the first user's company has a connection. The system logo can be installed by way of a browser plug-in. In FIG. 4, the first user has visited the web site of Goldman Sachs, and the logo has turned from gray to red. The system indicates to the first user that a second user at the first user's company (e.g. CBRE) has a connection to a target at Goldman Sachs. The system may also show icons (see, e.g., FIGS. 7 and 13) telling the first user the relationship source (based on various categories of the first user's Affiliate Network, for example) of who owns the relationship with the target at Goldman Sachs, without identifying whom the exact second user is. The first user can then accesses (e.g., clicks with the aid of a pointing device, such as a mouse) the logo to access potential relationships with users (targets) at Goldman Sachs. A drop-down frame (or menu) is provided to the first user, as shown in FIG. 5. The drop-down frame includes a list (FIG. 5, arrow 1) of all Goldman Sachs users (e.g., employees) to which one or more other users at CBRE, or the first user's Affiliate Network, has a connection. The list can include any contact at Goldman Sachs that the user is connected to through the user's affiliate network. The list can be populated by potential targets at Goldman Sachs, who have a connection to the first user (requester) by way of a facilitator at the first user's employer or Affiliate Network. The list can be populated by the system scanning an email server of the first user, such as an email server of the first user's company. In the drop-down frame, the system also presents the first user with the first user's personal connections (FIG. 5, arrow 2), such as Google+, Facebook, Twitter and/or LinkedIn connection. The first user can then request an introduction to one or more users provided in the list (FIG. 5, arrow 1) by clicking a logo under “Action” (arrow 3). With reference to FIG. 6, the first user has requested an introduction to a target (“Greg Engles”) at Goldman Sachs. The system presents the first user (requester) a frame to input a message to a facilitator at the first user's company. The first user does not know the identity of the facilitator, and is not informed of the identity of the facilitator by the system.

The system can also present information feeds about Goldman Sachs that, for example, include the latest news and observations, such as from Google+, Facebook, Twitter, and/or Linkedln. The observations can be from the general public or can be limited to people that the user is connected to through their social networks (or affiliate network).

### Example 2

FIG. 7 shows a WishList, as displayed on a web browser of a computer system of a user in communication with a system for facilitating user introductions, such as the system 130 of FIG. 1. The WishList allows the user to filter by various filtering criteria, such as location, phone, company, groups, common contacts, or any other Who@ member who has also filled out a WishList. The WishList includes a column showing connections the user can request (“Intros You Can Gain”), a column showing the introductions that the user can make (“Intros You Can Make”), a column displaying common contacts so the user knows who they know in common with the other user to help establish trust (e.g., by vetting out the other user through contacts in common), and a column allowing a user to provide a brief description of what they are selling once they get an intro. If a first user is not comfortable with what another user is selling, then the first user may not put the first user's reputation at potential risk by making an introduction for the other user to a target. The WishList also includes a column with a radio button enabling the user to request a connection (“Request Intro”). The user can gain connections to companies (e.g., Citigroup, HSBC). The user can also provide connections for other users.

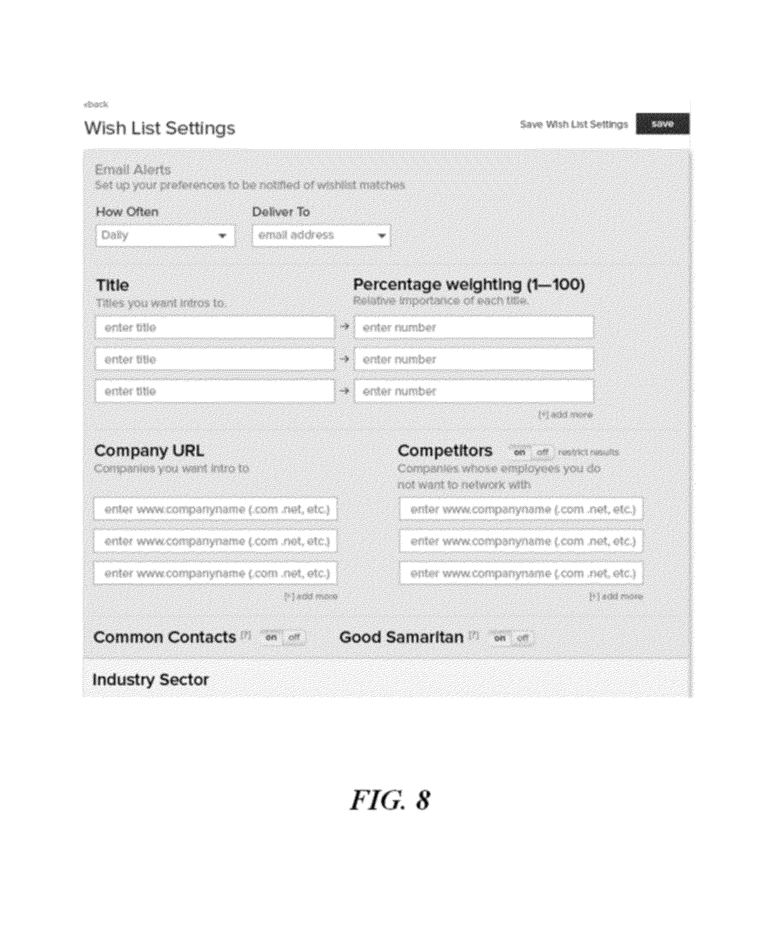

The system can enable the user to set or update WishList settings. FIG. 8 shows a graphical user interface (GUI) that enables the user to sign up for email alerts so that the system can notify the user when an introduction to a particular target that the user might want to meet becomes available. With the WishList, in an effort to provide an incentive for both users to help the other, both users can be both a requester and a facilitator as often times people barter whom they know to get an intro to someone they want to meet. An alert can be coupled with a search—that is, the system can conduct a search on the basis of various search criteria and alert the user when and if a match is found. For instance, the user can input the user's email address and provide an alert frequency (e.g., hourly, daily, weekly, monthly), and provide titles (e.g., Chief Executive Officer, Chief Technology Officer, Project Manager) of individuals the user wants to meet. The user can provide a measure of the importance of each title (“Percentage weighting”) to help optimize the system algorithm so the user gets the most relevant matches. Additionally, the user can input the URL of a company having targets that the user wants to meet, and competitors that the user does not want to network with in a quid pro quo manner. The system can notify (alert) the user when a target becomes available, such as through a facilitator (see FIG. 1). The system can permit the user to be a “Good Samaritan,” in which case the user can make introductions for another user (requester) even if the requester does not have a contact desired by the user.

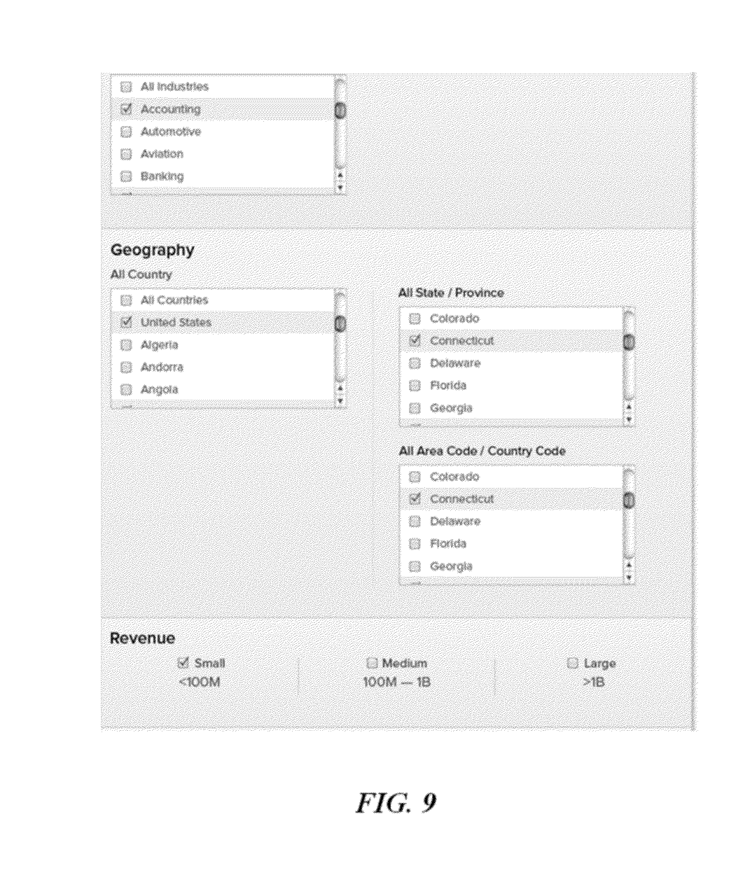

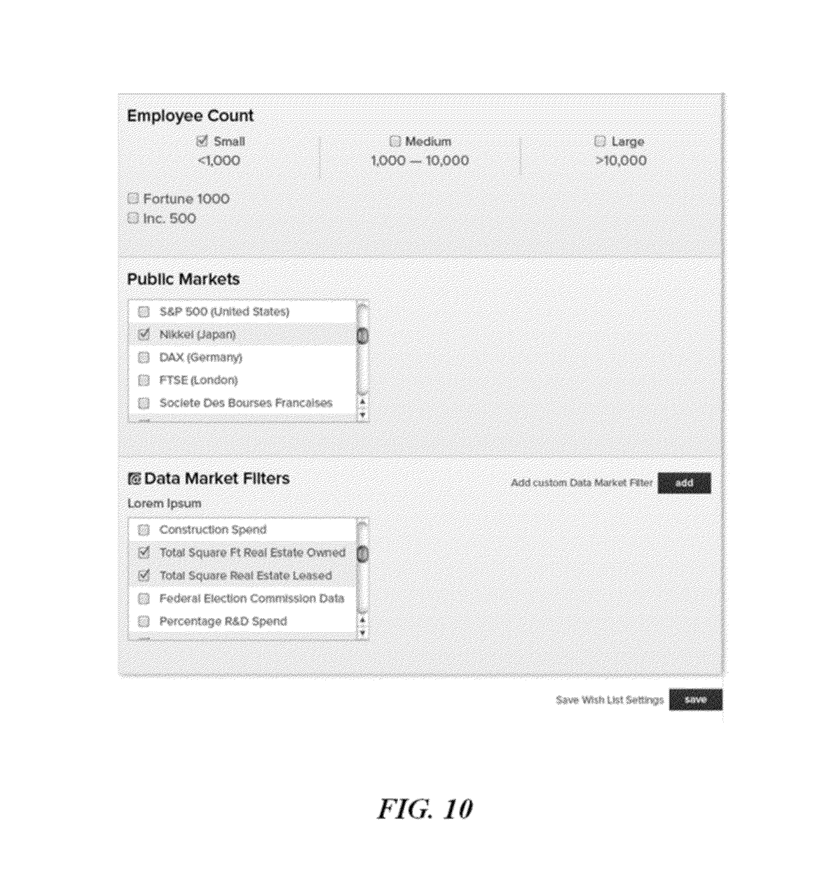

The user can provide the system with various search criteria to tailor a search and an alert to the user's preferences. Such criteria can be provided by following a link from the GUI of FIGS. 8, 9 and 10. With reference to FIG. 9, the user can set industry sector (e.g., “Accounting,” “Automotive”), geography (e.g., “United States,” “All Countries”) and revenue settings for enabling the system to tailor a search and subsequent alert to the user's preferences. With reference to FIG. 10, the user can provide employee count, public markets and filters based on the system's DataMarket data sources for the search and alert coupled under the WishList.

### Example 3

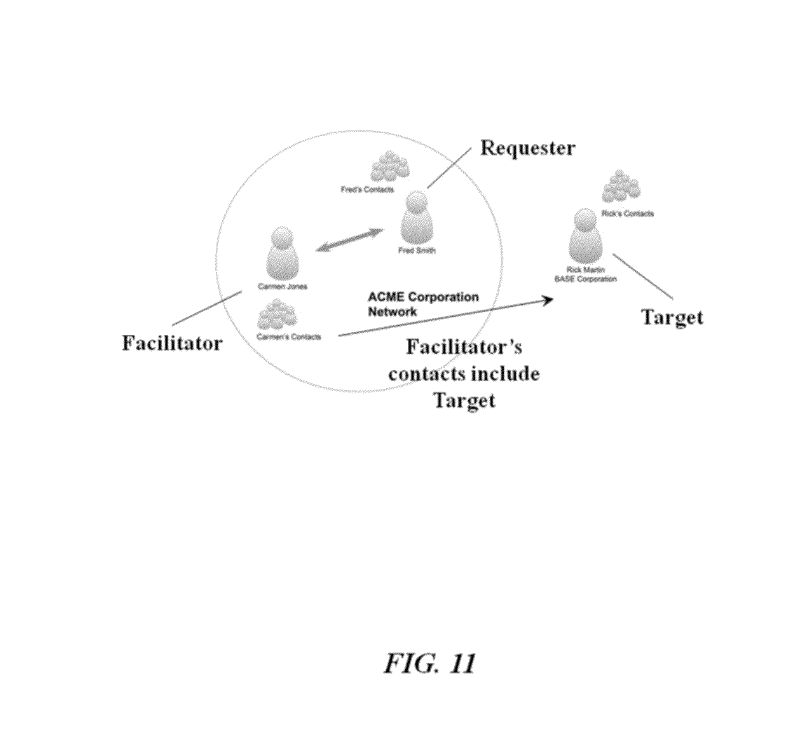

FIG. 11 shows an example in which Fred Smith wants to have an introduction to Rick Martin of BASE Corporation. Fred Smith is an employee of ACME Corporation (“ACME”). Carmen Jones is also an employee of ACME. A system facilitating user introductions, such as the system 130 of FIG. 1, scans Fred's contacts and Carmen's contacts and recognizes that Rick Martin is included in Carmen's contacts. Fred (requester) submits a request for an introduction to Rick. The system transmits a message (e.g., email) to Carmen (facilitator) indicating that Fred has made the request and asking Carmen for permission to introduce Fred to Rick. Fred is unaware of the identity of Carmen. Carmen elects to permit the system to introduce Fred to Rick. The system then transmits a communication (e.g., email) to Rick (target) introducing Fred to Rick. The system can indicate in the communication that one of Rick's contacts desires to introduce Fred to Rick. The system can provide Rick the name of the contact (Carmen Jones). In some cases, the system does not reveal any identifying information of Carmen to Fred. In other cases, however, Carmen can request that the system disclose one or more identifying information of Carmen to Fred. For instance, if Carmen clicks on a thumbs-up graphic, then her identity can be revealed to Fred.

In some cases, Carmen can make the actual introduction from Fred to Rick. In such a case, Carmen can notify the system that she “accepts” the request.

### Example 4

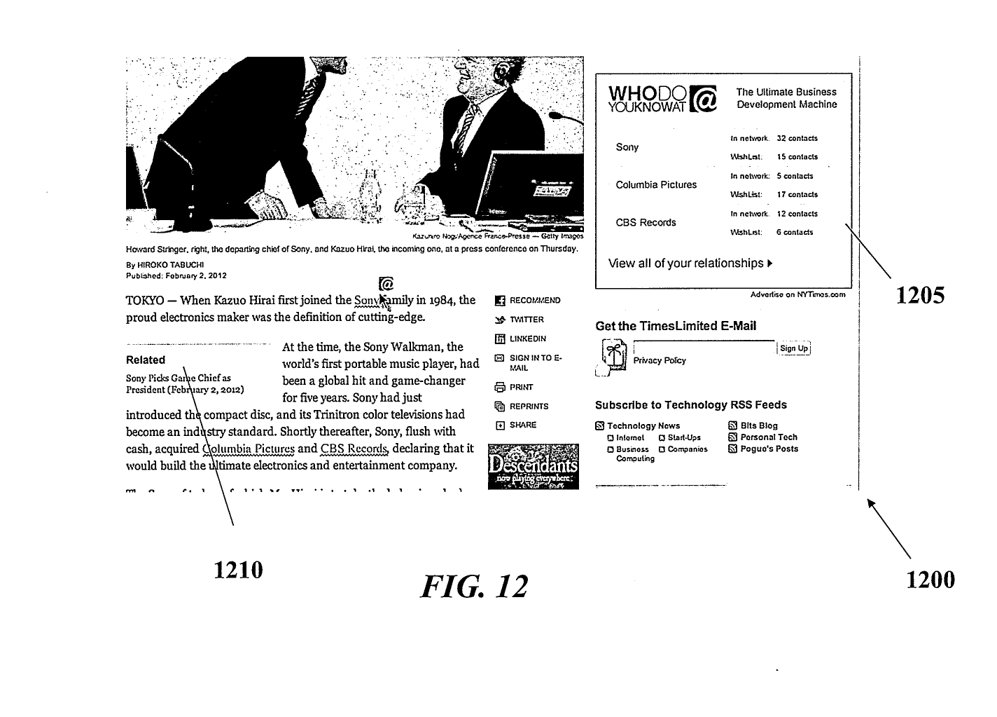

Systems provided herein can be implemented with the aid of either an API that the content site (e.g., NY Times) can utilize, or via a browser of a computer system of a user, such as through a browser plug-in that installs a GUI item. FIG. 12 shows a browser window 1200 having a frame 1205 showing the results of a search directed at web content 1210 of the window 1200. The frame 1205 can be installed by way of a browser plug-in or API, which brings the computer system of the user in communication with a system that facilitates user introductions, such as the system 130 of FIG. 1 or the system 300 of FIG. 3. As the user navigates the World Wide Web, the system, through the plug-in or API, reviews the web content 1210 to search for potential targets for the user to request an intro through via a facilitator. The system then displays the results of the search in the frame 1205. In the illustrated example, the web content 1210 mentions “Sony,” “Columbia Pictures,” and “CBS Records.” In some cases, the system can display the name, title and company of potential targets. The system searches the aforementioned companies (or users) and provides the user a tally of the number of other users in the user's network (Affiliate or in-network on the top half of frame 1205) that have connections to the companies (or users), and the number of other users in the user's WishList that have connections to the companies. The WishList may be populated by facilitators that the user may want to meet. The system can then permit the user to request an introduction to one or more users in one or more of the companies displayed in the frame 1205, either through an in-network contact or through a WishList contact. The user can click on the “View all of your relationships” link in the frame 1205 to view additional details of the connections to the companies mentioned in the web content 1210, as shown in FIG. 13.

In some cases, the system can permit the second user (facilitator) to make an introduction to a target that is on the first user's WishList. This can permit the second user to introduce other targets if the second user has a connection to a company mentioned in the web content 1210.

### Example 5

Systems provided herein can be programmed to implement a DataMarket that can enable a user to see all relationships that the user's company has with other users or entities, such as business entities (e.g., retailers). For instance, the DataMarket can enable a user to see all relationships that the user's company has with retailers having more than 50 retail units, and their locations, which users will spend more than $100 million in construction in a given year. The DataMarket can mash up multiple data sources, such as databases on corporate or personal information that is then appended to the contacts of each member. The system can look at the URL of each company, or other unique company identifier, run that through the DataMarket, and then allow a user to filter on criteria relevant to the user's company. The DataMarket's intent is to be able to have any Who@ user filter their relationships, or set criteria of the kinds of companies or people they want to meet, via the mash up of multiple data sources as described, for example only, above with disparate data such as contacts, retailers and construction spend. The structure of the DataMakarket allows for this and many other filters based on the data sources Who@ adds to the DataMarket.

### Example 6

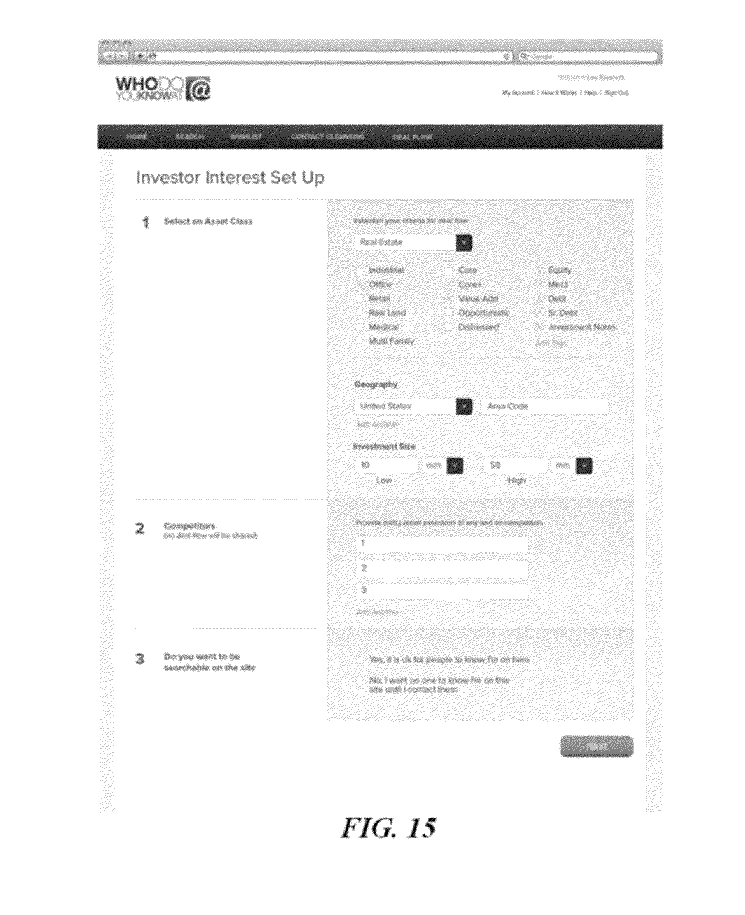

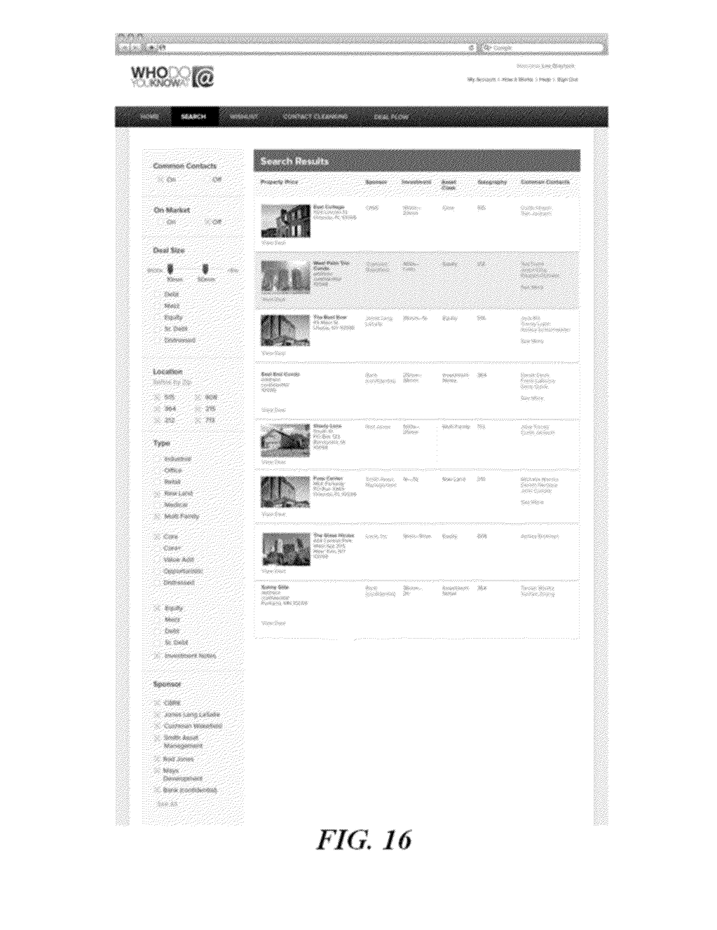

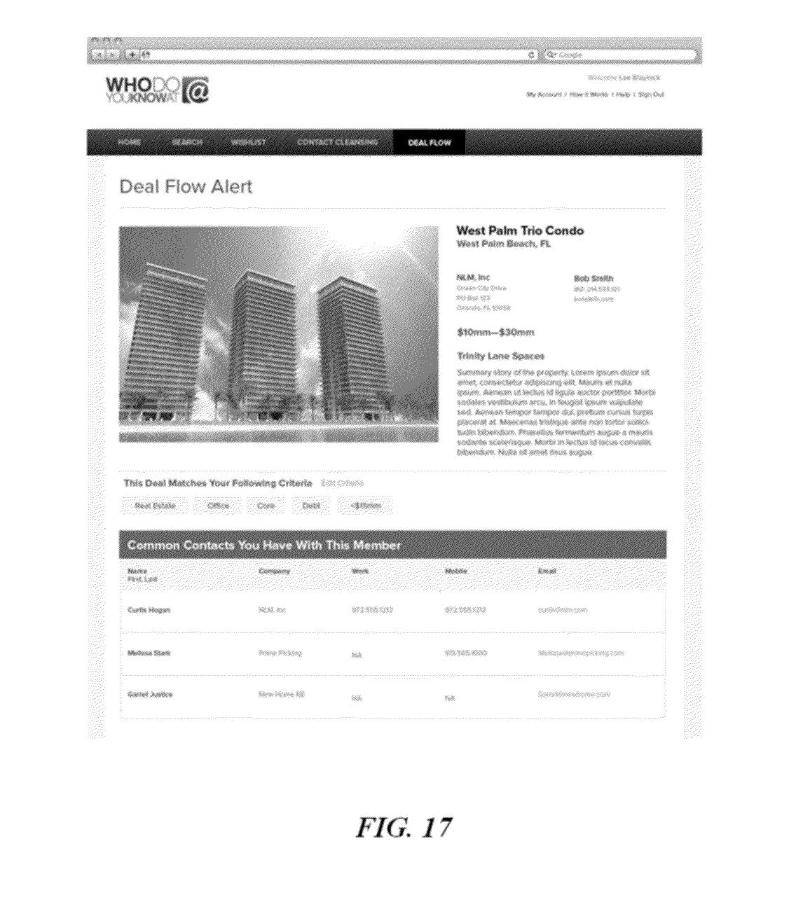

Systems provided herein can enable a user to locate potential investors by leveraging the user's contacts. In some situations, the user can locate potential investors by the system matching the investor's criteria and the promoter's criteria, while at the same time showing Common Contacts so that the investor may call their colleagues who also know the promoter to get a reference on them before contacting the promoter. FIGS. 15-17 show screenshots of a graphical user interface showing a user's search for potential real estate investors (sample asset class only). In FIG. 15, the user (investor) inputs search criteria for a potential deal, such as investment size and the type of real estate sought. With reference to FIG. 16, the system provides the user (investor) a listing of real estate investments that match the user's search criteria. The system also displays contacts that the user has in common with the individual(s) or entity selling the real estate, which common contacts that are in common with the user conducting the search. The user can elect to contact one or more of the common contacts associated with a potential transaction for a reference on that promoter to gauge their interest in the deal based on that reference (common contact). With reference to FIG. 17, the user has selected the West Palm Trio Condo real estate from the list of FIG. 16, and the system provides information on the potential deal and a list of common contacts that the user has with the individual(s) or entity selling the real estate. In some embodiments, the promoter does not have to reveal the exact location of the real estate asset or the name of the fund for which they are trying to raise capital.

### Example 7

Mary is a customer of ServiceProvider, a company that offers a given service. Bill is a customer of ServiceProvider. Mike is a new buyer that does not know Mary, but knows Bill. Mike and Bill have each other identified in their contacts databases. Mike uses a system that manages user endorsements, such as the system of FIG. 3, to identify which of Mike's contacts has endorsed a particular service or product. In an example, Mike visits ServiceProvider's web site, and a GUI of the system identifies Bill as a user among Mike's contacts who has endorsed ServiceProvider. The system does not identify Mary because Mary is not among Mike's contacts. The system then permits Mike to get a referral to ServiceProvider from Bill.

### Example 8

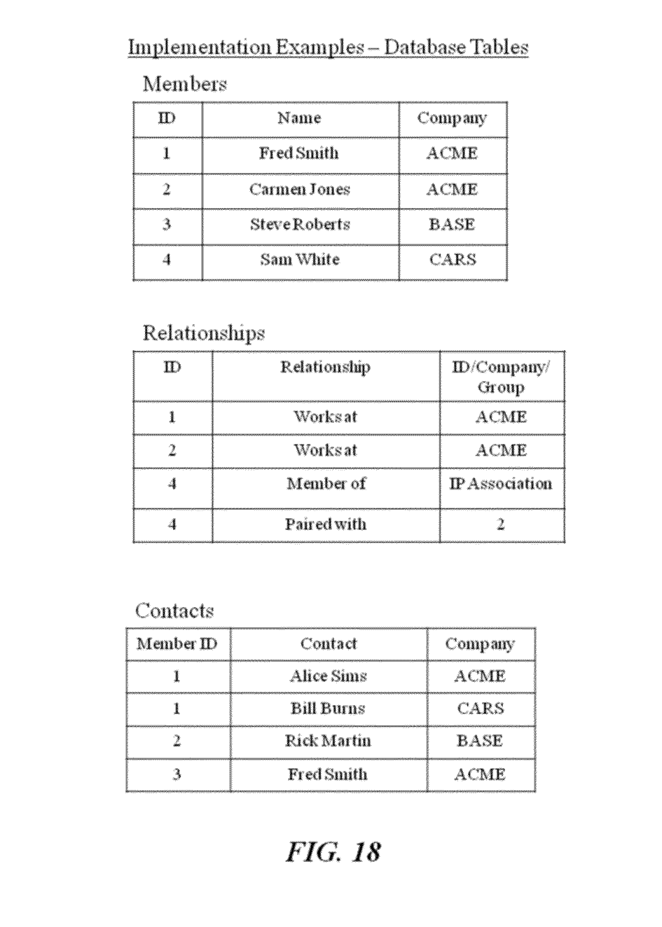

FIG. 18 shows database tables having users of a system configured to facilitate user introductions, such as the system 300 of FIG. 3. The database includes a Members table, Relationships table, and Contacts table. The Members table includes user names (“Name”), a unique identifier (“ID”) associated with each user, and a company (“Company”) of each user. The company column can list a company or group (or organization) of each user. For example, user Fred Smith having ID 1 works at ACME. The Relationships table includes a relationship column (“Relationship”) having a relationship string that describes the relationship of each user to the company of the user. For example, the user identified by ID 1 (Fred Smith) works at ACME. The Contacts table provides rows with one or more contacts of each user. For example, Fred Smith (ID 1) has Alice Sims of ACME and Bill Burns of CARS as contacts.

Systems provided herein can analyze various contact records and determine which records correspond to the same actual person or entity, even if the various contact records are incomplete. This process of determining matching contact records can be called root resolving or resolving contact records to root records, with the term root meaning a contact record that corresponds to an actual person. Once contact records have been resolved to roots, then systems may provide further analysis of contact records. Such further analysis can determine that multiple users know the same person or can provide the basis for determining common contacts between two users or groups of users.

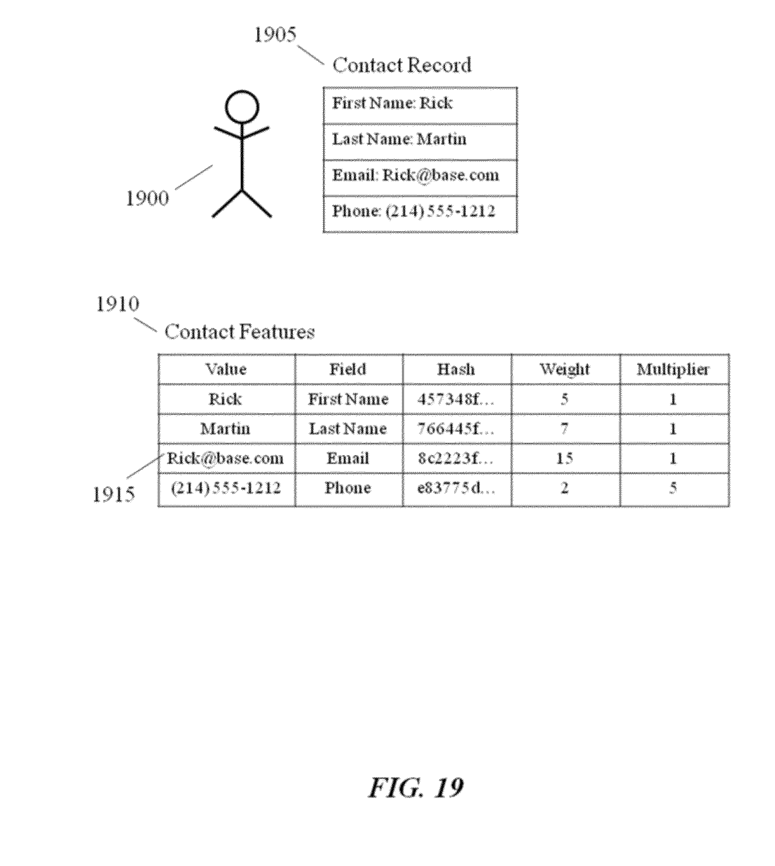

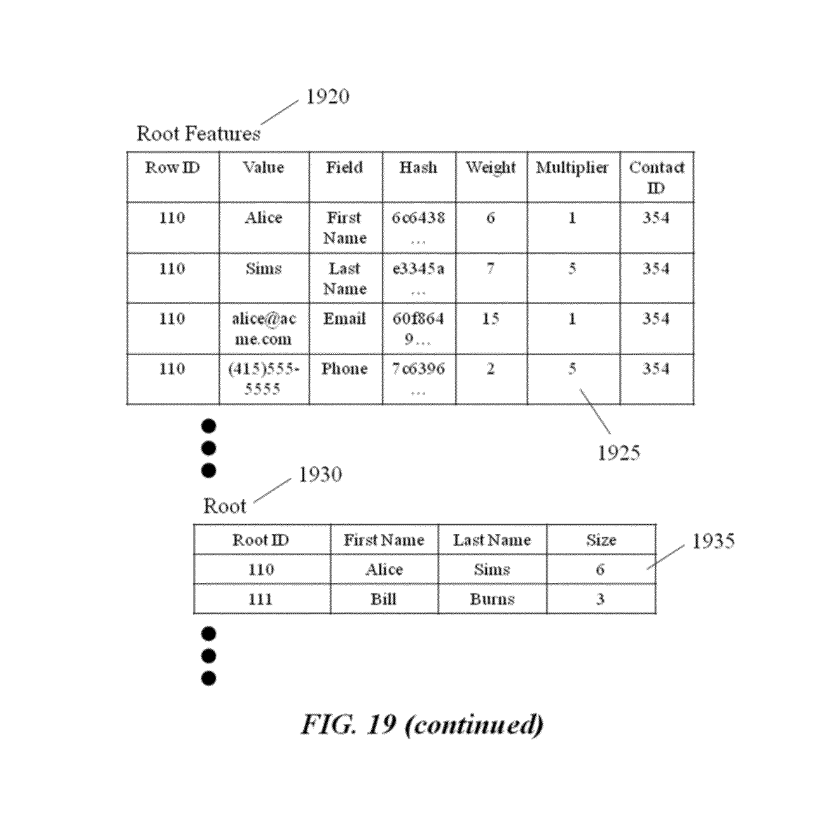

FIG. 19 illustrates an example of a root resolving process. A contact record 1905 is introduced to the system representing the data about person or entity 1900, typically by a user uploading their contact databases to the system. The contact record 1905 is composed of various fields describing person 1900 such as First Name, Last Name, Email Address, Phone Number, and other fields corresponding to information about person or entity 1900. The system translates the various fields from contact record 1905 into contact features 1910. A contact feature 1915 may consist of but is not limited to a contact field value, a hash of that value, and assigned weight, and an optional multiplier. The hash of the value is derived using a one-way hash function, which can be one of several methods for calculating one-way hash functions including MD5, SHA-1, SHA-512, and others. A weight for the feature is assigned based on a priority of various fields in determining the uniqueness of a contact record. And the optional multiplier is assigned based on additional properties of the field being pertinent to determining the uniqueness of a contact record, such as if an email address has been verified by a user.

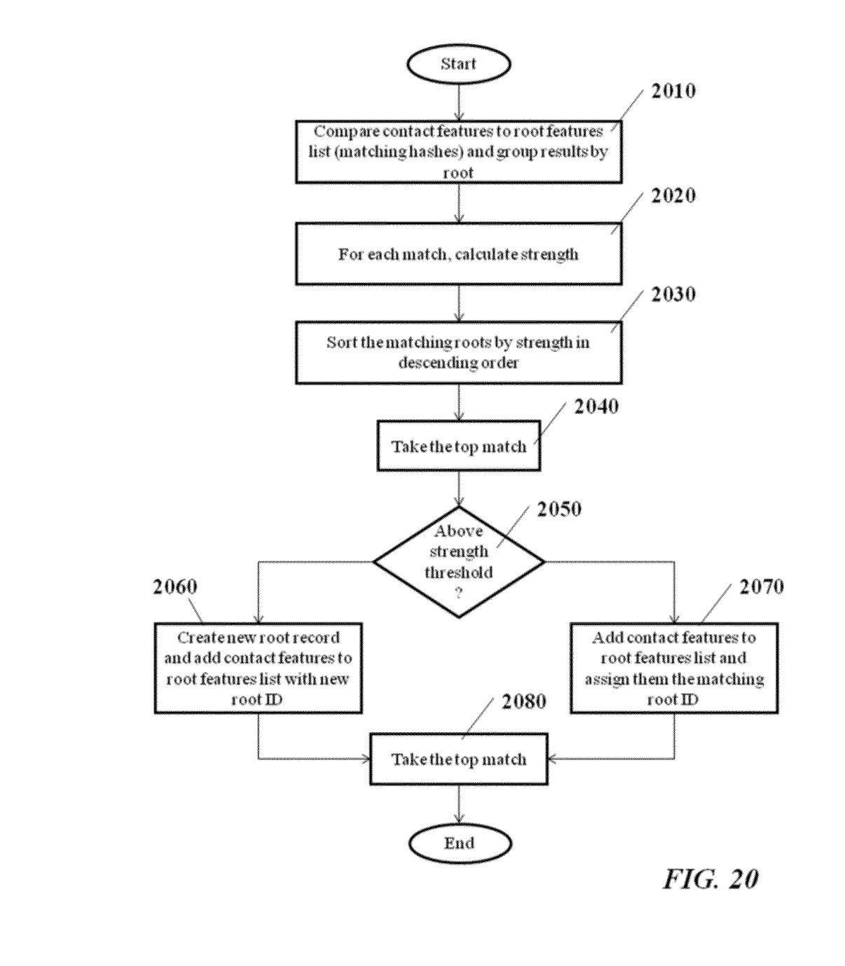

As described in FIG. 20, a contact record may be identified as a new root or may be identified as a match to an existing root. In the event that the contact record is identified as a new root, then the constituent contact features 1910 are added to the root features list 1920 and a new root record is added to the root record list 1930. Each contact feature 1915 is added to the root features list 1920 and is associated with a contact ID indicating a particular contact record in the user's contact list and a root ID indicating a particular root record in the root record list 1930. The new root record 1935 consists of but is not limited to a new root ID, interesting fields identifying the root such as First Name and Last Name, and a size value that indicates how many contact records in the system correspond to the root record.

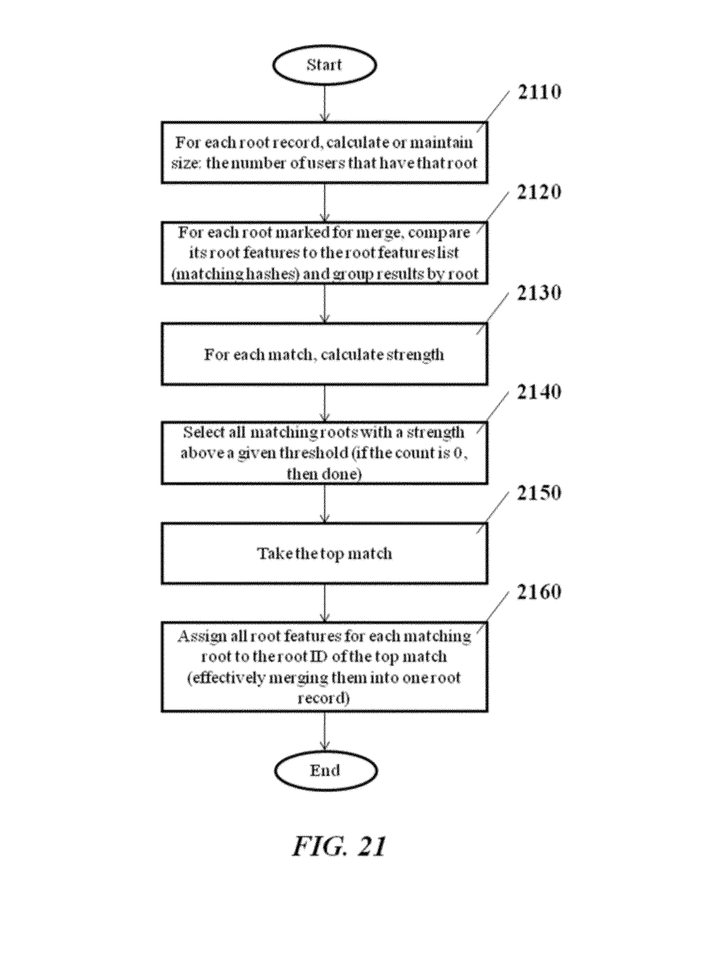

FIG. 20 illustrates an example of the root resolving process wherein a contact record is determined to be a new root record 1935 or to match an existing root 1935. In step 2010, each contact feature 1915 is compared with the list of root features 1920 to determine possible matches. The hash of each contact feature 1915 is compared with the hash of each root feature 1925 to create a set of matching records. For each matching record, a calculation is applied wherein the weight of the contact feature 1915 is multiplied by the optional multiplier for each contact feature 1915 and the results are summed and grouped by root ID. The results are summed as indicated by step 2020 to determine a strength of match. The strength is equal to Σᵢ₌₀ⁿ(weight)ᵢ(multiplier)ᵢ, wherein ‘n’ is the number of fields that match. The resulting groups of matches are sorted by the strength of match step 2030. The highest match is determined step 2040. If the match is above a given match threshold 2050, then a match is determined to exist between contact features 1910 and root record 1930. If there is no match above the given threshold 2050, then the contact features 1910 are determined to represent a new root record and the new record is created 2060 as described in the previous paragraph. If a match has been determined, then the contact features 1910 are inserted 2070 into root features list 1920 and given the root ID of the matching root record 1935. The root record 1935 is marked to be merged 2080 for the subsequent merging process illustrated in FIG. 21.

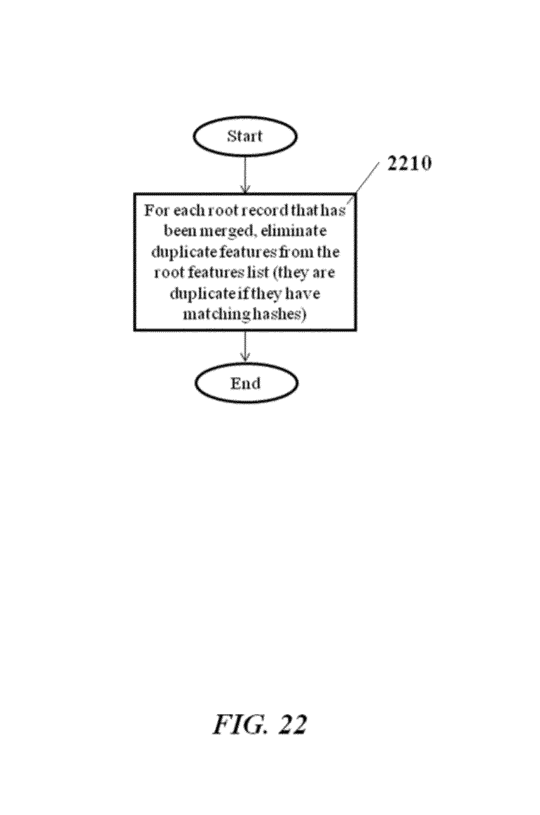

Subsequent to the resolving process illustrated in FIG. 20, a merge process is performed as illustrated in FIG. 21. For each root record 1935 that is marked for merging, the merge process is performed. Each root record 1935 is assigned a size parameter (step 2110) that corresponds to the number of contact records that have been determined to match each root record 1935. The root features 1925 for each root record 1935 to be merged are compared (step 2120) with the list of root features 1920. For each matching root record 1935, a strength calculation is applied wherein the weight of the root feature 1925 is multiplied by the optional multiplier for each root feature 1925 and the results are summed and grouped by root ID (step 2130). The strength is equal to Σᵢ₌₀₀ⁿ(weight)ᵢ(multiplier)ᵢ, wherein ‘n’ is the number of fields that match. All matching root records 1935 with a strength above a certain threshold (step 2140) are selected. The resulting root records 1935 are sorted based on size and the root record 1935 with the highest size value is selected (step 2150). The root ID for the selected root record 1935 is then applied (step 2160) to the rest of matching root records 1935 from step 2140, effectively merging the selected records into one root record (they are all assigned the same root ID). Subsequent to the merge process, a collapse process is performed as illustrated in FIG. 22.

FIG. 22 illustrates the collapse process. For each master root record determined in the merge process, the collapse process is performed. The list of matching root features 1920 for each master root record 1935 is analyzed for duplicate root features. Any root features that are determined to be duplicates are eliminated (step 2210) so that the root features 1920 corresponding to root record 1935 is the minimal list of unique root features.

There are a number of advantages to the root resolving process described herein. The root resolving process allows contact records which may be incomplete and/or outdated to be matched with other contact records in the system and thereby determine that the contact records refer to the same actual person or entity. One embodiment of the process allows the root features 1925 to be stored without identifying information (just retaining the hash), so that contact information stays confidential. The originating contact record can be deleted and the actual personally identifying information such as first name, last name, email, or phone number would not linger in the root features list. The root resolving process also allows for reverse lookups to be made. Given, for example, an email address, that email address can be hashed and that hashed looked up in the root features list. The corresponding root record can then be identified.

Systems provided herein can determine common contacts between two users, or between a user and a group of users, or between two groups of users. FIG. 23 illustrates the steps taken to determine common contacts. The steps can be implemented by a computer system (“system”), as describe elsewhere herein. The first user or group is User/Group A and the second user or group is User/Group B. In step 2305 the system determines a list of contacts or roots for User/Group A (referred to as Set A). In step 2310 the system determines a list of contacts or roots for User/Group B (referred to as Set B). In step 2315 the system computes the intersection of Set A and Set B (referred to as the Result Set). The Result Set contains the list of contacts that are common to User/Group A and User/Group B, referred to as common contacts.

### Example 9

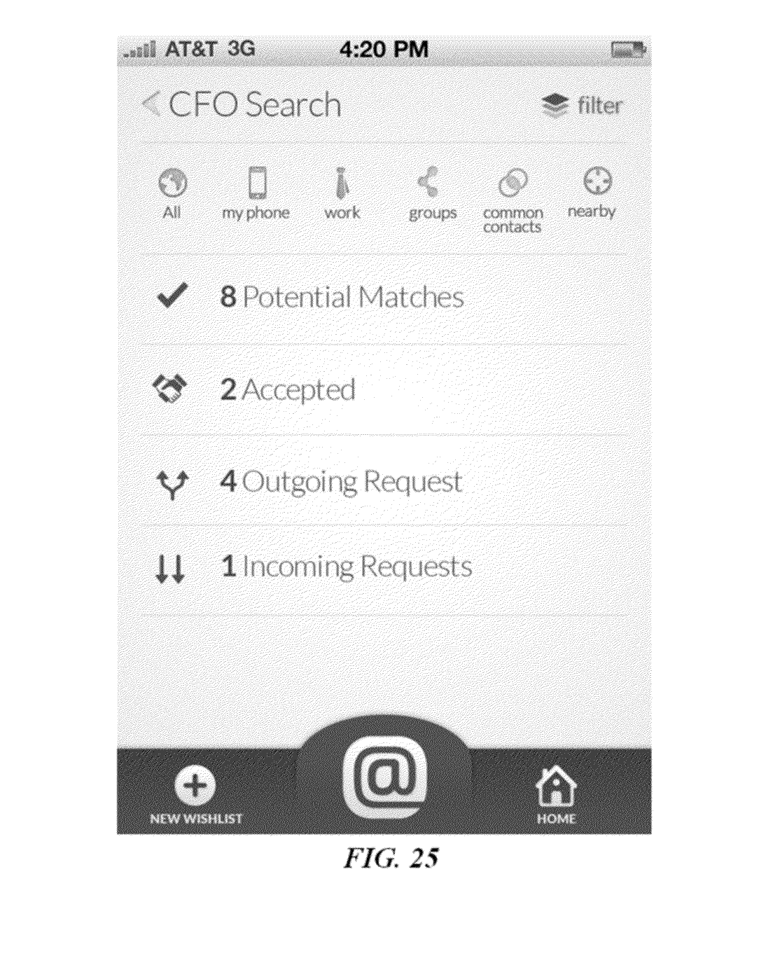

FIGS. 24 and 25 show screenshots of GUI's. The GUI of FIG. 24 enables a user to create a WishList. The GUI of FIG. 25 shows various features and functionalities, such as “Potential Matches,” “Accepted” requests, “Outgoing Request,” and “Incoming Requests.” The GUI's can be implemented on an electronic device of a user, which is in communication with a system (e.g., system 300 of FIG. 3).

It should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A computer-implemented method for facilitating user introductions, comprising:
(a) receiving a request from a requester for an introduction to a target;
(b) conducting, with the aid of a computer processor, a search for one or more facilitators that are directly linked to said target;
(c) requesting authorization from a given facilitator among said one or more facilitators to introduce said requester to said target, wherein said authorization is requested with the aid of an electronic notification on a user interface of an electronic display of said given facilitator; and
(d) upon receiving authorization from said given facilitator, revealing the identity of said given facilitator to said requester, wherein said requester is subsequently introduced to said target.

2. The computer-implemented method of claim 1, wherein, in (c), said given facilitator is anonymous to said requester.

3. The computer-implemented method of claim 1, wherein said requester and said one or more facilitators belong to an affiliate network.

4. The computer-implemented method of claim 3, wherein said target is not part of said affiliate network.

5. (canceled)

6. The computer-implemented method of claim 1, further comprising authenticating said requester upon receiving said request in (a).

7. (canceled)

8. The computer-implemented method of claim 1, wherein said requester is introduced to said target with the aid of said given facilitator.

9. The computer-implemented method of claim 1, further comprising, subsequent to (d), directing an electronic communication to said requester with identifying information of said given facilitator.

10. The computer-implemented method of claim 1, further comprising directing an electronic notification to said requester that authorization from said given facilitator has been received.

11. The computer-implemented method of claim 1, wherein, prior to (a), said target is identified to said requester through a root resolving process.

12. A computer-implemented method for facilitating user introductions, comprising:
(a) receiving a request from a requester for an introduction to a target, wherein said target is directly linked to a facilitator, and wherein said requester and facilitator belong to an affiliate entity;
(b) requesting, with the aid of a computer processor, authorization from the facilitator to introduce said requester to said target, wherein said authorization is requested with the aid of an electronic notification on a user interface of an electronic display of said facilitator, wherein the identity of said facilitator is not identified to the requester; and
(c) upon receiving authorization from said facilitator, introducing said requester to said target.

13. The computer-implemented method of claim 12, wherein said target is not in said affiliate entity.

14. The computer-implemented method of claim 12, wherein said user interface is a graphical user interface.

15. (canceled)

16. (canceled)

17. The computer-implemented method of claim 12, further comprising, in (c), directing an electronic communication to said target with identifying information of said requester.

18. A computer-implemented method for facilitating user introductions, comprising:
(a) reviewing, with the aid of a computer processor, graphical and/or textual content on a web site;
(b) determining, with the aid of a computer processor, one or more targets from said content for introduction to a requester;
(c) displaying, on a user interface of said requester, a list having said one or more targets, wherein said list is generated upon reviewing said graphical and/or textual content on said web site;
(d) receiving a request from said requester for an introduction to a given target among said one or more targets, wherein said given target is directly linked to a facilitator, and wherein said requester and facilitator belong to an affiliate entity;
(e) requesting, with the aid of a computer processor, authorization from the facilitator to introduce said requester to said given target; and
(f) upon receiving authorization from said facilitator, facilitating the introduction between said requester and said given target.

19. (canceled)

20. The computer-implemented method of claim 19, wherein, in (e), said introduction is facilitated by revealing the identity of the facilitator to the requester.

21. The computer-implemented method of claim 18, wherein said authorization is requested with the aid of an electronic notification on a user interface of an electronic display of said facilitator.

22.-25. (canceled)

26. The computer-implemented method of claim 18, further comprising, in (e), directing an electronic communication to said target with identifying information of said requester.

27. The computer-implemented method of claim 1, further comprising: (e) providing, with the aid of a computer processor, the facilitator an introduction credit for use in requesting an introduction from said requester or another user.

28.-34. (canceled)

35. The computer-implemented method of claim 27, further comprising storing said introduction credit in a memory location.

36. The computer-implemented method of claim 1, wherein, in (d), said requester is introduced to said target by directing an electronic communication to said target with identifying information of said requester.

37. A computer-implemented method for updating user contact information, comprising:
(a) reviewing, with the aid of a computer processor, contact information relating to a first user in a contacts database of a second user;
(b) determining, with the aid of a computer processor, if said contact information is outdated; and (c) if said contact information is outdated, requesting authorization from said first user to (i) update said contact information and/or (ii) notify said second user that said contact information is outdated.

38. The computer-implemented method of claim 37, wherein said authorization is requested with the aid of an electronic notification on a user interface of an electronic display of said first user.

39.-41. (canceled)

42. The computer-implemented method of claim 37, further comprising updating said contact information in said contacts database of said second user.

43. The computer-implemented method of claim 37, wherein, in (c), authorization is requested if said first user has been verified.

44. A computer-implemented method for facilitating user introductions, comprising:
(a) providing, on a user interface of an electronic device of a requester, one or more targets to said requester;
(b) receiving a request from said requester to place a given target among said one or more targets on a wish list of said requester, wherein said wish list is maintained in a memory location;
(c) providing said given target in said wish list; and
(d) conducting, with the aid of a computer processor in communication with said memory location, a search for one or more facilitators that are directly linked to said target.

45. The computer-implemented method of claim 44, wherein a given facilitator among said one or more facilitators has a target included in a wish list of said given facilitator, wherein said target is directly linked to the requester.

46. The computer-implemented method of claim 44, wherein said one or more facilitators are in an affiliate network of said requester.

47. The computer-implemented method of claim 46, wherein said target is not in said affiliate network.

48. The computer-implemented method of claim 44, further comprising identifying a facilitator from said one or more facilitators, and facilitating the introduction between said requester and said target with the aid of said facilitator.

49. The computer-implemented method of claim 48, wherein said facilitator is anonymous to said requester.

50. A computer-implemented method for providing product and/or service referrals, comprising:
(a) receiving, from a first user, an indication of a willingness to provide a referral for a product and/or service;
(b) receiving a request from a second user for said referral;
(c) determining, with the aid of a computer processor, if said second user is in a contacts database of said first user;
(d) if said second user is in said contacts database of said first user, requesting said referral from said first user; and
(e) providing said referral to said second user.

51. The computer-implemented method of claim 50, wherein said contacts database is associated with a social network of said first user.

52. The computer-implemented method of claim 50, wherein (c) further comprises determining if said first user is in a contacts database of said second user.

53. The computer-implemented method of claim 52, further comprising, in (d), requesting said referral from said first user if said first user is in said contacts database of said second user.

54. The computer-implemented method of claim 50, wherein said first user and second user are in an affiliate network.

55. The computer-implemented method of claim 50, wherein, in (e), said referral is provided on a user interface of an electronic device of said second user.

56. A computer-implemented method for providing potential deals, comprising:
(a) conducting, with the aid of a computer processor, a search of a deals database for potential deals, wherein said search is conducted based on search criteria inputted by a first user
(b) displaying, on an electronic display of an electronic device of said first user, a list of one or more results that meet said search criteria, wherein a given result of said one or more results is associated with a deal that is promoted by a second user;
(c) identifying, with the aid of a computer processor, a third user that is a common contact between said first user and said second user; and
(d) providing identifying information of said third user on said electronic display.

57. The computer-implemented method of claim 56, wherein said one or more results are generated based on a correlation with successful deals.

58. The computer-implemented method of claim 56, wherein said first user and third user are in an affiliate network.

59. The computer-implemented method of claim 58, wherein said second user is not in said affiliate network.

60. The computer-implemented method of claim 56, wherein said second user is anonymous to said first user.

61. The computer-implemented method of claim 56, further comprising, subsequent to (d), introducing said first user to said second user with the aid of said third user.

62. The computer-implemented method of claim 56, wherein said potential deals are real estate deals.

63. A computer-implemented method for facilitating user introductions, comprising:
(a) conducting, with the aid of a computer processor, a search of a database for one or more targets that match a profile provided by a requester;
(b) conducting, with the aid of a computer processor, a search for one or more facilitators that are directly linked to a given target among said one or more targets; and
(c) alerting said requester of the presence of a given facilitator among said one or more facilitators that is directly linked to said given target.

64. The computer-implemented method of claim 63, wherein, in (c), said given facilitator is anonymous with respect to said requester.

65. The computer-implemented method of claim 63, further comprising generating, with the aid of a computer processor, said profile.

66. The computer-implemented method of claim 63, further comprising requesting authorization from said given facilitator to introduce said requester to said target, wherein said authorization is requested with the aid of an electronic communication directed to said facilitator for display on a user interface of an electronic display of said given facilitator.

67. The computer-implemented method of claim 66, further comprising revealing the identity of said given facilitator to said requester upon receiving authorization from said given facilitator, wherein said requester is subsequently introduced to said target.

68. The computer-implemented method of claim 63, wherein said given facilitator and requester are in an affiliate network.

69. The computer-implemented method of claim 68, wherein said target is not in said affiliate network.

70. The computer-implemented method of claim 63, wherein said profile comprises information selected from the group consisting of company size, industry, number of employees, net income %, company real estate and company expenditure.

71. The computer-implemented method of claim 63, wherein, in (c), an alert is provided on an electronic display of an electronic device of said requester.

72.-80. (canceled)
